(19) United States
(12) Patent Application Publication
(10) Pub. No.: US 2006/0253391 A1
(43) Pub. Date: Nov. 9, 2006

(54) Method, apparatus, and computer readable medium for facilitating transactions

(76) Inventor: Leslie L Jacobs JR., Bethesda, MD (US)

Correspondence Address: Michael N Haynes, 1341 Huntersfield Close, Keswick, VA, 22947, US

(21) Appl. No.: 10/515,866

(22) PCT Filed: Nov. 24, 2004
(86) PCT No.: PCT/US04/39672

§ 371 Date: Nov. 24, 2004

Related U.S. Application Data
(60) Provisional application No. 60/524,842, filed on Nov. 26, 2003.

(51) Int. Cl. G06Q 40/00

(52) U.S. Cl. 705/40

(57) ABSTRACT

Certain exemplary embodiments provide methods, apparatuses, and computer readable media for facilitating transactions involving contractual rights to receive payments resulting from the transfers of interests in intellectual property assets.

### CROSS REFERENCE TO RELATED APPLICATIONS

This application claims priority to, and incorporates by reference herein in its entirety, pending U.S. Provisional Patent Application Ser. No. 60/542,842 (Docket Number BMP-3A), filed 26 Nov. 2003.

### BRIEF DESCRIPTION OF THE DRAWINGS

Certain features, aspects, and/or advantages of will become better understood with reference to the following description, appended claims, and accompanying drawings of certain exemplary embodiments, in which:

FIG. 1 depicts the interaction of parties negotiating a transaction involving intellectual property asset(s), and another party who purchases one or more contractual rights to receive future payments resulting from the transaction involving the intellectual property asset(s).

FIG. 2 depicts the interaction of parties associated with a completed transaction involving one or more intellectual property assets, and the parties to a transaction involving at least one or more contractual rights to receive one or more future payments in exchange for the transfer(s) of interest(s) in one ore more the intellectual property rights. FIG. 2 also shows the relationship of one of those parties with a special purpose vehicle, and the investors who purchase from the special purpose vehicle securities backed by one or more contractual rights to receive one or more payments resulting from the licensing, sale or leasing of the one or more intellectual property assets.

FIG. 3 depicts a variation on the interaction shown in FIG. 2, wherein the royalty payment is serviced by an entity other than the special purpose vehicle.

FIGS. 4A and 4B are flow charts depicting the acts corresponding to methods that are in accordance with certain exemplary embodiments.

FIGS. 5A and 5B are flow charts depicting the acts corresponding to methods that are in accordance with certain exemplary embodiments.

FIGS. 6A and 6B are flow charts depicting the acts corresponding to methods that are in accordance with certain exemplary embodiments.

FIGS. 7A and 7B are flow charts depicting the acts corresponding to methods that are in accordance with certain exemplary embodiments.

FIG. 8A depicts a network environment, including a computer system, which can facilitate implementation of certain exemplary embodiments. FIG. 8B depicts how at least one entity may access an electronic list via, for example, the network of FIG. 8A in accordance with certain exemplary embodiments.

FIG. 9 depicts a first record containing information regarding a requested transaction involving an intellectual property asset, the first record being stored in a database system coupled to the computer system shown in FIG. 8A.

FIG. 10 depicts a second record containing information regarding a completed transaction involving an intellectual property asset, the second record being stored in a database system coupled to the computer system shown in FIG. 8A.

FIG. 11 depicts a third record containing information regarding a requested transaction involving a contractual right to receive payments that was received in exchange for the transfer of interests in one or more intellectual property assets, the third record being stored in a database system coupled to the computer system shown in FIG. 8A.

FIG. 12 depicts a list assembled from, for example, information contained in records detailing completed transactions involving intellectual property assets, such as the second record shown in FIG. 10, and records detailing requested transactions involving contractual rights to receive one or more payments in exchange for intellectual property asset(s), such as the third record shown in FIG. 11. The list may be dynamically created and stored in a database system of the computer system shown in FIG. 8A for later retrieval.

### DETAILED DESCRIPTION

Intellectual property asset interest holders (e.g., owners and licensees) are presently seeking to exploit their intellectual property assets to a much greater extent than in the past. The exploitation of intellectual property assets has lead to an increase in revenues for these intellectual property asset interest holders that is based on the licensing, sale or leasing of those intellectual property assets. By way of example, the licensing of intellectual property assets provides an intellectual property asset interest holder with a contractual right to receive a future stream of royalty payments, which are based on the sales of products and/or services incorporating the intellectual property asset(s). These royalty payments often extend over time and end in accordance with the terms of the license agreement upon which the royalty payments are based. An intellectual property asset interest holder may also seek to sell or lease intellectual property rights to another entity in return for a stream of fixed or variable payments.

A disadvantage associated with receiving a future stream of payments as a result of transactions involving intellectual property assets is that an intellectual property asset interest holder may desire to receive a present cash payment instead of waiting to receive future payments. By way of example, the present cash payment would correspond to the net present value of the future stream of payments (e.g., royalty payments). By receiving a present cash payment, the business entity could reinvest the money in its core business to achieve a higher rate of return.

Certain exemplary embodiments relate to methods, computer systems, and computer readable media for facilitating transactions involving contractual rights to receive payments resulting from the transfer(s) of rights in intellectual property assets. By way of example, the intellectual property assets may include patents, patent applications, copyrights, trademarks and trade secrets.

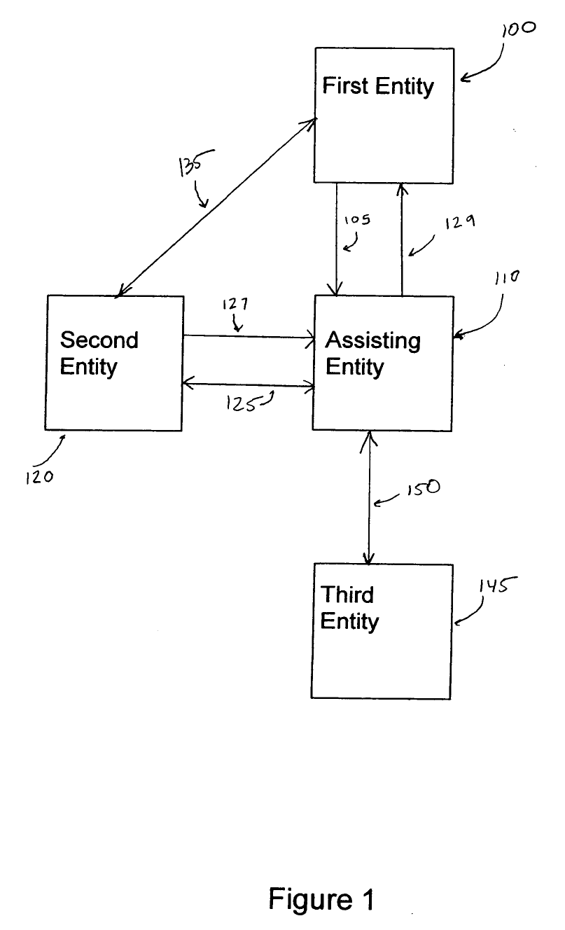

FIG. 1 depicts the interaction of parties associated with a transaction involving an intellectual property asset, the transaction being facilitated in accordance with certain exemplary embodiments. FIG. 1 shall be discussed in the context of a transaction involving the licensing of one or more intellectual property assets. However, one of ordinary skill in the art will appreciate that there may be other transactions involving intellectual property assets, including the sale or leasing of intellectual property assets.

In FIG. 1, a first entity 100 (e.g., the licensor) makes a request 105 to another entity to assist with a transaction involving of one or more intellectual property assets. By way of example, the assisting entity 110 assisting with the transaction may be an assisting entity 110 who assists with, for example, the licensing of one or more intellectual property assets. The request 105 comprises information about the type of transaction sought, the nature of the intellectual property asset(s) involved in the transaction and terms of the transaction.

For a transaction involving the licensing of an intellectual property asset, the information will include, for example, the type of license (i.e., exclusive or non-exclusive) sought for the intellectual property asset, the nature of the intellectual property asset and the terms associated with the license. The terms associated with the license will include, for example, the duration of the license, the minimum royalty rate (fixed or variable) sought by the licensor, the number of royalty payments, the periodicity of those royalty payments (e.g., monthly, quarterly, or yearly), and any restrictions placed on the license (territorial or otherwise).

The assisting entity 110 assists with the transfer(s) of one or more interests in one or more intellectual property assets (e.g., the licensing of intellectual property asset(s)) by, for example, arranging for a second entity 120 (e.g., a potential licensee) to review 125 information that the assisting entity 110 has received from the first entity 100 concerning the intellectual property asset.

The assisting entity 110 may also assist the first entity with the transfer(s) of interest(s) in intellectual property asset(s) by, for example, acquiring those interest(s) and aggregating them with multiple other interests in intellectual property assets (that have been acquired from multiple entities) for the purpose of licensing the aggregated interests in intellectual property assets to other entities such as the second entity 120. By way of example, the assisting entity 110 may be a performing rights organization.

The first and second entities may be individuals, partnerships (both general and limited), corporations, trusts, limited liability partnerships, or limited liability companies.

The assisting entity 110 may arrange for such a review by sending information to potential licensees in the form of periodicals, e-mails, or instant messaging. Alternatively, the assisting entity 110 may arrange for such a review by attracting the second entity 120 to a vehicle of electronic commerce, such as a web site or online facility maintained by a commercial online service provider (e.g., America Online). Information concerning the intellectual property asset(s) may be provided via the web site or online facility.

Once the second entity 120 reviews the information concerning the intellectual property asset, the second entity 120 may submit 127 a letter of interest (which may be in the form of an e-mail) expressing a desire to enter into a contractual agreement regarding the transfer of interest(s) in the intellectual property asset(s) (e.g., a licensing agreement) or submit an offer (i.e. bid) to enter into such an agreement under terms specified as part of the information provided by the first entity 100 in its request 105 to the assisting entity 110 regarding the intellectual property asset(s). Alternatively, the second entity 120 may contact 135 (or be contacted by) the first entity 100 directly to negotiate the terms of a contractual agreement (e.g., license agreement) which results in the first entity 100 receiving a contractual right to receive future payment(s) in exchange for the transfer of interest(s) in the intellectual property asset(s) to the second entity 120.

If the second entity 120 submits 127 a letter of interest or an offer, the submitted offer will be processed by the assisting entity 110 who will, in turn, provide 129 the same to the first entity 100 along with other letters of interest or offers to enter into a contractual agreement (e.g., a license agreement) involving the transfer of one or more interests in one or more intellectual property assets in exchange for the right to receive one or more payments, including a future payment. The first entity 100 (i.e. the licensor) would decide based on the offers submitted which of the offers was a successful offer. If the second entity 120 submitted the successful offer, the first entity 100 may contact the second entity 120 and enter 135 into a contractual agreement with the second entity 120 if that entity 120 submits the most favorable offer.

Alternatively, the assisting entity 110 may process bids involving intellectual property assets by specifying on behalf of the first entity 100 the terms under which an offer to acquire one or more interests in one or more intellectual property assets (e.g., an offer to take a license with respect to one or more intellectual property assets) would be accepted, and permitting potential licensees to bid by, for example, specifying a particular criterion or a combination of criteria. For licenses, these criteria may include, for example, the royalty rate and the period of the license.

By way of example, the assisting entity 110 may process the offers (or bids) in an online auction format in the manner described in U.S. Patent Application Publication No. 2002/0004775, which is incorporated herein by reference.

Thereafter, instead of providing 129 letters of interest or offers to the first entity 100, the assisting entity 110 would instead provide the first entity with a notification of the successful offer.

Once the transaction between the first entity 100 and the second entity 120 is completed the first entity 100 will receive in exchange for the transfer of rights in at least one or more intellectual property assets a contractual right to receive at least one payment or multiple payments, including at least one future payment. The first entity 100 may desire to assign the contractual right to receive at least one payment or multiple payments for a present cash payment or for a promise to receive a payment much sooner than the first entity 100 would expect to receive the payment under the terms associated with the contractual right to receive at least one payment or multiple payments. The first entity 100 may cause the contractual right to receive at least one payment or multiple payments resulting from the transfer of rights in intellectual property assets to be included on a list (e.g., an electronic list) of such contractual rights, a transferable interest in each of which is being offered for sale. The list is made accessible to other entities that are interested in purchasing the transferable interest in contractual rights to receive payments resulting from the transfer(s) of rights in intellectual property assets.

Preferably, the transferable interest in each of the contractual rights is made available for transfer along with a security interest in an intellectual property asset. Advantageously, the transferable interest in some or all of the contractual rights is made available for transfer apart from any rights associated with intellectual property assets except a security interest in one or more intellectual property assets. In this way, the entities (e.g., the second entity 120) that acquire transferable interests in the intellectual property assets that were received in exchange for the contractual rights to receive payments can retain those interests in the intellectual property assets unimpeded if the payments are made.

The list of contractual rights may be made available in the form of periodicals, e-mails, or instant messaging. Alternatively, the list of contractual rights may be made available for review by potential purchasers via a vehicle of electronic commerce, such as a web site or online facility maintained by a commercial online service provider.

By way of example, the assisting entity 110 (e.g., a broker) assisting the first entity 100 with the transaction involving at least one intellectual property asset may provide 150 other entities, such as a third entity 145, with access to a list of a group of contractual rights to receive future payment(s), a transferable interest in each, of which, is being offered for sale. This group would include the aforementioned contractual right to receive at least one payment or multiple payments that was transferred from the second entity 120 to the first entity 100.

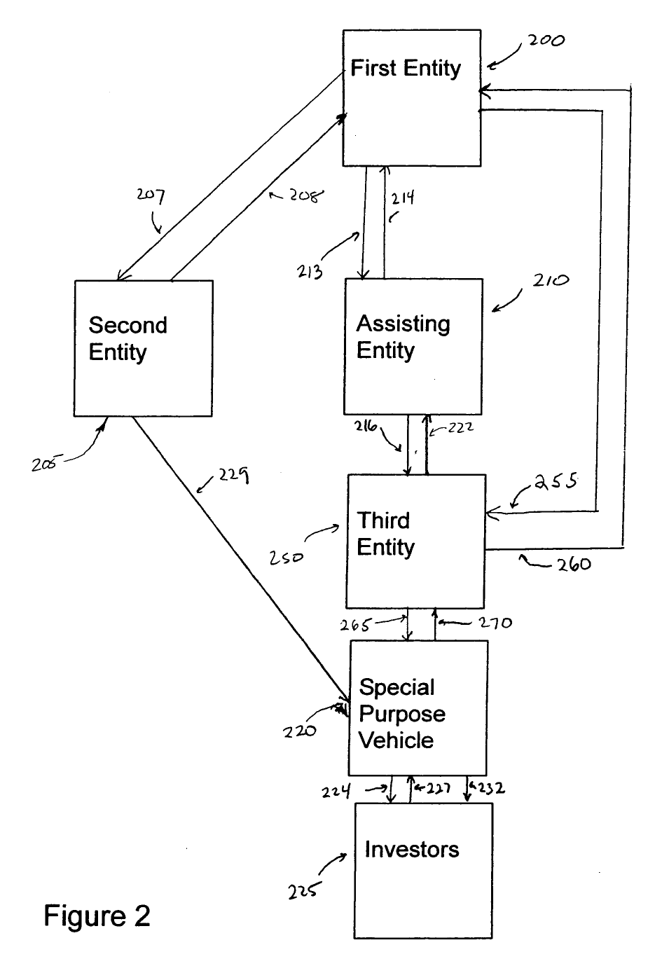

FIG. 2 depicts the interaction of the parties associated with a completed transaction involving one or more intellectual property assets, and a transaction involving at least one or more contractual rights to receive one or more future payments in exchange for the transfer(s) of interest(s) in one ore more intellectual property rights. FIG. 2 also shows the relationship of one of those parties with a special purpose vehicle, and the investors who purchase from the special purpose vehicle securities backed by one or more contractual rights to receive one or more royalty payments resulting from the licensing, sale or leasing of the one or more intellectual property assets.

As shown in FIG. 2, a first entity 200 (e.g., licensor) and a second entity 205 (e.g., licensee) enter 207 and 208 into a contractual agreement (e.g., a licensing agreement) involving the transfer(s) of interest(s) in one or more intellectual property assets. The contractual agreement (e.g., licensing agreement) provides for the second entity 205 to receive 207 the interest(s) in the intellectual property asset(s) (e.g., the first entity 200 would agree not to exclude the second entity 205 from, for example, making, using or selling products and/or services associated with the intellectual property asset(s)) from the first entity 200. In exchange, the second entity 205 provides 208 the first entity 200 with at least a contractual right to receive a group of payments (the group including one or more payments) from the second entity 205 in accordance with the terms of the contractual agreement. The group of payments comprises one or more future payments. By way of example, the payments may include royalty payments under a licensing agreement.

Although FIG. 2 shows the first entity 200 and the second entity 205 directly negotiating in the contractual agreement, the assisting entity 210 (e.g., a broker) may be useful in facilitating the contractual agreement between the first entity 200 and the second entity 205, as noted above.

Once the contractual agreement has been completed, the assisting entity 210 may receive from the first entity 200 a request 213 to assist with another transaction involving the transfer to a third entity 250 of an interest in the contractual right to receive a group of payments (which may include one or more future payments) received in exchange for a transfer of interest(s) in intellectual property asset(s). The request may be an electronic request made via email or by posting the request to a vehicle of electronic commerce, such as a Website.

By way of example, the transfer of an interest in the contractual right to receive a group of payments (e.g., royalty payments) may involve the transfer of an ownership interest in the contractual right in exchange for a present cash payment or, for example, a promise to receive at least one or more future payments much sooner than the first entity 200 would otherwise expect to receive the payment under the terms associated the contractual right.

As noted above, the transferable interest in each of the contractual rights is made available for transfer along with a security interest in one or more intellectual property assets, an interest in one or more of the intellectual property assets having been received in exchange for one or more of the contractual rights. Advantageously, the transferable interest in some or all of the contractual rights is made available for transfer apart from any rights associated with intellectual property assets except a security interest in the one or more intellectual property assets. In this way, the entities (e.g., the second entity 205) that receive transferable interests in the intellectual property assets that were exchanged for the contractual rights to receive payments can retain those interests unimpeded if the payments are made.

Following the receipt of the request 213, the assisting entity 210 will confirm 214 the receipt of the request 213. The confirmation may be accomplished electronically and be sent by way of email, instant messaging, or a posting on a Website. In response to the request 213 to assist with the transfer of an interest in the contractual right to receive a group of royalty payments (including at least one royalty payment), the assisting entity 210 comprises the contractual right to receive a group of royalty payments on a list as mentioned above in connection with FIG. 1.

As an alternative to listing the contractual right to receive a group of payments directly on behalf of the first entity 200, the assisting entity 210, who is assisting the first entity with the transaction involving at least one intellectual property asset) may first acquire an interest in the contractual right and then list the contractual right on its own behalf. In this way, the assisting entity 210 may assist the first entity 200, as well as other entities, if such entities cannot wait for another entity to acquire the contractual rights they are seeking to transfer. Thereafter, the assisting entity 210 may provide 216 at least a third entity 250 with access to the list in the manner described above.

The third entity 250 may review 222 the list to determine whether it wishes to acquire any of the contractual rights identified therein. By way of example, the list of contractual rights may be made available in the form of periodicals, e-mails, or instant messaging. Alternatively, the list of contractual rights may be made available for review by potential purchasers via a posting to a vehicle of electronic commerce, such as a web site or online facility maintained by a commercial online service provider.

Preferably, the transferable interest in each of the contractual rights found in the list is made available for transfer along with a security interest in an intellectual property asset. The list may provide an explicit indication that the contractual rights identified therein are being offered with a security interest in one or more intellectual property assets. Advantageously, the transferable interest in some or all of the contractual rights is made available for transfer apart from any rights associated with intellectual property assets except a security interest in one or more intellectual property assets.

After having reviewed 222 the list, the third entity 250 may acquire (or purchase) 255 and 260 the contractual right to receive a group of royalty payments (including one or more royalty payments) from the first entity 200. In such an instance, the first entity 200 (or the assisting entity 210 if it has acquired the contractual right) will assign 255 the contractual right to the third entity 250 (or a receiving entity that may be different than the third entity 250) and the third party 250 will provide 260 some consideration to the first entity 200 in return.

The consideration may include a cash payment or a promise to make a cash payment at a future date, which is sooner than the first entity 200 might otherwise receive compensation in accordance with the terms of the contractual right. The third entity 250 (or a receiving entity that may be different than the third entity 250 if the third entity 250 has been reviewing the aforementioned list on the receiving entity's behalf) will then transfer 265 (e.g. assign) the contractual right to receive a group of royalty payments to a special purpose vehicle 220 and the third entity 250 (or a receiving entity that may be different than the third entity 250) will receive 270 some consideration from the special purpose vehicle 220 in return. The consideration may include a cash payment and/or a promise to make a cash payment at a future date.

Following the transfer 265 of the contractual right to receive a group of royalty payments to the special purpose vehicle 220, the special purpose vehicle 220 will issue 224 securities to investors 225. The securities will be backed by the contractual right to receive a group of royalty payments. In return, the investors 225 will provide 227 the special purpose vehicle 220 with cash. Thereafter, the second entity 205 will provide 229 royalty payments to the special purpose vehicle 220, which will, in turn, make 232 principle and interest payments to the investors 225. Alternatively, the special purpose vehicle 220 may transfer the contractual right to receive a group of royalty payments to a trust (not shown), which will, in turn, issue the securities backed by the contractual right to receive a group of royalty payments.

The special purpose vehicle 220 need not directly service the royalty payments from the second entity 205. Another entity may be used to service such payments on behalf of the special purpose vehicle 220.

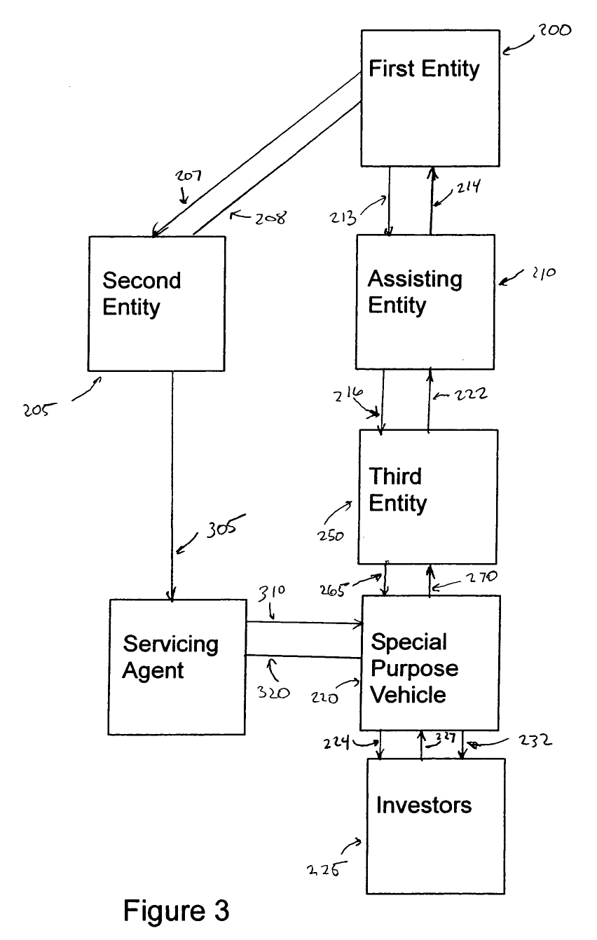

FIG. 3 depicts a variation on the interaction shown in FIG. 2, wherein the royalty payment is serviced by an entity other than the special purpose vehicle. Preferably, the assisting entity 210 (or an entity assisting with the transaction involving the contractual rights) may be employed to service payments on behalf of the special purpose vehicle 220.

FIG. 3 will only be explained to the extent that it differs from the interaction shown in FIG. 2. In particular, a servicing agent 300 receives 305 each royalty payment from the second entity 205 and provides 310 that royalty payment to the special purpose vehicle in return for a servicing fee 320.

The use of asset-backed securities permits the conversion of a stream of income associated with an intellectual property asset into a cash payment representing the net present value of that stream of income. An entity (such as a licensor, lessor or seller) having a contractual right to receive future payments flowing from another entity's use of an intellectual property asset would most likely be left with the prospect of having to wait for those future payments.

With the advent of intellectual property (IP) based asset-backed securities, an entity can convert a stream of income associated with an intellectual property asset into its net present value less the transaction fees associated with the issuance of those IP based asset-backed securities. The use of these financial tools provides the third entity 250 with a great deal of flexibility in financing the acquisition of additional contractual rights flowing from the transfer(s) of interest(s) in intellectual property assets.

As to the issuance of IP based asset-backed securities, it is important to note that the income generated by intellectual property assets is usually a function of a future stream of royalty payments, as is the case with the licensing of an intellectual property asset. While there is nothing inherently wrong with receiving a stream of royalty payments, it may be more advantageous to receive the net present value of that stream of royalty payments in one lump sum so as to allocate that capital to the acquisition of additional intellectual property assets which can produce an even higher rate of return on investment. Notwithstanding the variability associated with royalty payments, the financial community has increasingly recognized the value that can be associated with intellectual property assets and has taken steps to harness this value through the use of IP-based asset backed securities.

Traditionally, asset backed securities have relied upon assets, which are tied to a predictable income stream. These assets include credit card debt and mortgages. Because the delinquencies associated with both unsecured and secured debt are very predictable, the expected rate of return on investments associated with these securities can be accurately determined. Investments associated with intellectual property assets involve not only substantial legal risk but also substantial commercial risk. Hence, if one seeks to convert a contractual right to receive a future stream of royalty payments into a single cash payment, investors must be found who are willing to shoulder the legal and commercial risks associated with the intellectual property asset underlying that stream of royalty payments.

Presently, there are investment bankers who traffic in IP-based securities, such as the Pullman Group headed by David Pullman. (see www.pullmanco.com). David Pullman has successfully sold bonds which have been backed by the licensing royalties associated with David Bowie's catalog of copyrighted music. The licensing royalties associated with album sales are a function an artist's copyright interest in the songs appearing on the album. A more detailed analysis of the transaction involving the Bowie bonds can be found in an article entitled, “Bowie Bonds Sold for Far More than a Song: The Securitization of Intellectual Property as a Super-Charged Vehicle for High Technology Financing”, Santa Clara Computer and High Technology Law Journal, Vol. 15, No. 1, January 1999.

Patents involve substantially more legal risk than do copyrights. Thus, while investors have recognized the value of copyrighted music and have been willing to invest in securities backed by the royalties flowing from that copyrighted music, securities backed by the royalties flowing from patented technology present greater risks. Hence, absent credit enhancements, the rate of return offered on these IP-based asset backed securities involving patents may have to be very high, perhaps comparable to the rate of return associated with junk bonds.

The issuance of IP-based asset backed securities involves several steps. Initially a special purpose vehicle must be established. The special purpose vehicle may be a partnership (limited or general), corporation, limited liability partnership, limited liability company or Delaware Intellectual Property Holding Company. Once the special purpose vehicle is established, the assets which will ultimately back the IP-based asset backed securities are transferred to the special purpose vehicle to facilitate the issuance of those securities. In particular, the assets are sold to the special purpose vehicle so that the special purpose vehicle may issue those securities. The assets, which are transferred to the special purpose vehicle, may include one or more contractual rights to receive royalties from the sale of goods and services which incorporate one or more intellectual property assets. These assets may also include one or more contractual rights to receive payments associated with the sale or leasing of one or more intellectual property assets. The assets may further include a security interest in one or more of the intellectual property assets, a transferable interest in each of which has been exchanged for the contractual rights.

The reason for setting up the special purpose vehicle is to isolate the assets from any credit problems of the originator, which in this instance is the entity acquiring the contractual right to receive a stream of future payments from, for example, a licensor, lessor or seller of intellectual property assets. In this regard, the special purpose vehicle should secure a perfected security interest in the assets that are transferred to the special purpose vehicle. This protects the assets, and hence the ultimate purchasers of the asset backed securities, from the reach of creditors if the originator itself faces the prospect of bankruptcy.

After a security interest has been perfected in the transferred assets, the special purpose vehicle may issue securities (i.e., the IP-based asset backed securities) in the manner prescribed by law. Thereafter, the assets must be serviced to ensure that the securities holders are properly compensated.

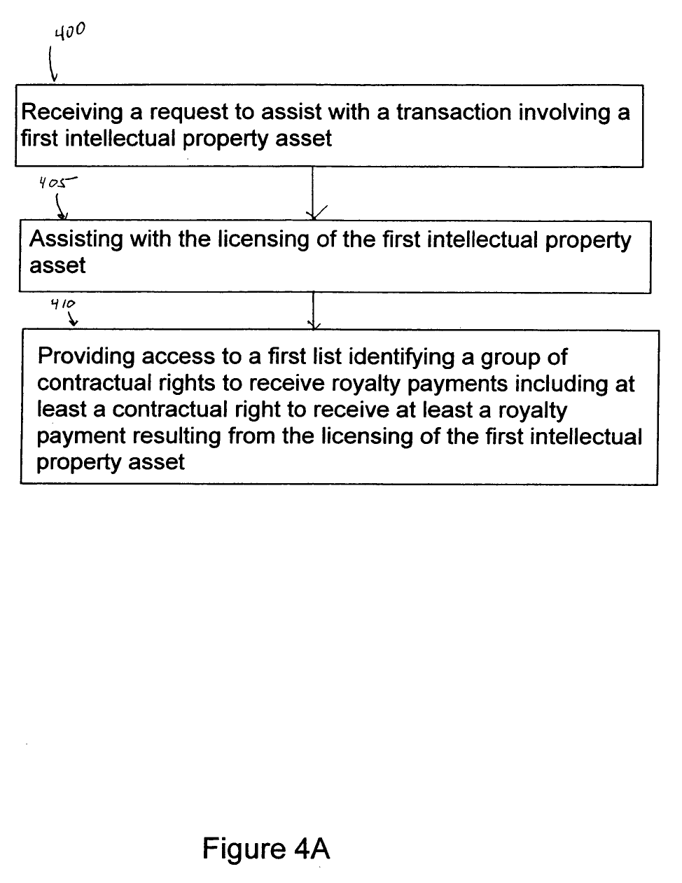

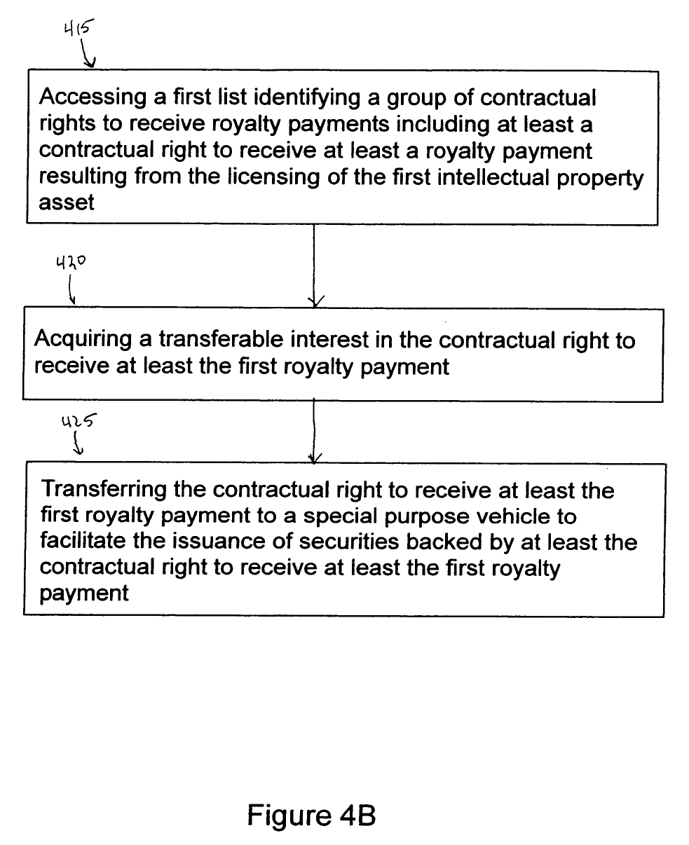

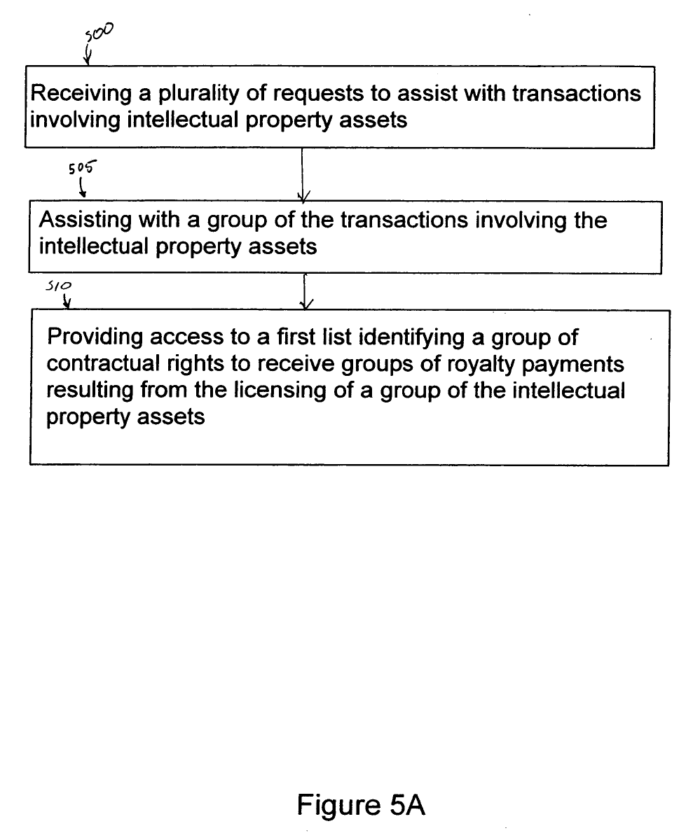

FIG. 4A is a flow chart depicting the acts of a method of facilitating transactions involving one or more contractual rights to receive payments resulting from the transfer(s) of rights in one or more intellectual property assets in accordance with certain exemplary embodiments.

In step 400, an assisting entity (e.g., broker) receives a request to assist with a transaction involving a first intellectual property asset from a first entity, the transaction including a licensing of the first intellectual property asset. In step 405, the assisting entity assists with the licensing of the first intellectual property asset to at least a second entity (or multiple entities), the licensing resulting in the first entity securing a first contractual right (or multiple contractual rights) to receive at least a first royalty payment (or multiple royalty payments) from the second entity. In step 410, the assisting entity provides a group of entities including a third entity with access to a first list identifying a first group of contractual rights to receive royalty payments including at least the first contractual right to receive at least the first royalty payment (or multiple royalty payments).

For each contractual right identified in the list, a transferable interest in that contractual right is made available for transfer (e.g., purchase) to a receiving entity. Advantageously, the transferable interest in some or all of the contractual rights is made available for transfer apart from any rights associated with intellectual property assets except a security interest in one or more of the intellectual property assets (e.g., the above-mentioned first intellectual property asset). In this way, the entities (e.g., the second entity) that receive transferable interests in the intellectual property assets that were exchanged for the contractual rights to receive payments can retain those interests unimpeded if the payments are made.

The first group of contractual rights to receive royalty payments may also include a second contractual right to receive at least a second royalty payment (or multiple royalty payments) based on the licensing of a second intellectual property asset.

Although a contractual right may have been received in exchange for the transfer of an interest in a single intellectual property asset, it is also contemplated that a contractual right may have been received in exchange for the transfer(s) of interest(s) in multiple intellectual property assets. With regard to the contractual rights included on the list, it may be attractive from the third entity's point of view to identify and/or acquire contractual rights having a common association type or to identify and/or acquire contractual rights whose value is based on intellectual property assets having a common association type. The entire list may be dedicated to contractual rights having a common association type or to contractual rights associated with intellectual property assets having a common association type. As an alternative, the list may be segmented such that a section of the list comprises only contractual rights having a common association type, or comprises only contractual rights associated with intellectual property assets having a common association type.

An example of a group of intellectual property assets having a common association type is a group of intellectual property assets associated with a particular type of product or service, or a combination of related product(s) and service(s) because the third entity may have a keen understanding of the market potential for those products and/or services, thereby allowing the third entity to more readily gauge the commercial risks associated with acquiring those contractual rights. As an example, the intellectual property assets may be associated with computer peripherals (e.g., disk drives). As a result, the value of the contractual rights to receive royalty payments resulting from the licensing of intellectual property assets associated with computer peripherals would likely reflect the success of those products in the market place. The risk that royalty payments may decrease is directly linked to the success of computer peripheral sales in the market place.

Another example of a group of intellectual property assets having a common association type is a group of intellectual property assets associated with products and/or services sold in a particular industry or to a particular market segment. In this way, the risk that those royalty payments may decrease is directly linked to the success of those products and/or services in a particular industry or to a particular market segment.

An industry is made up of sellers who provide a particular type of product or service (e.g., computer peripherals), or a class of products or services (e.g., computer products). A market is made up of a group of buyers whose particular needs are addressed by an industry through the sale of a particular type of product or service or a class of products or services. A market segment is a subset of the group of buyers making up a market, the subset of that group of buyers having particular characteristics. By way of example, a market segment may include high-end buyers of computer peripherals, who seek the best computer peripherals that money can buy with the most advanced features. The reason for segmenting a market stems from the fact that the performance of a particular segment of a market may be superior to that of the market as a whole, and investors may find it advantageous to invest in contractual rights associated with intellectual property assets employed in products or services associated with a particular market segment.

By way of example, if royalty payments are based on the sales of computer peripherals made by the computer peripheral industry, then the risk that royalty payments may decrease is directly linked to the success of the computer peripheral industry, as a whole. Similarly, if royalty payments are based on products sold to the market segment including buyers of high-end computer peripherals, then the risk that royalty payments may decrease is directly linked to the success of computer peripheral sales to that particular market segment.

It may also be preferable to acquire contractual rights to receive royalty payments resulting from the licensing of intellectual property assets, if the contractual rights have a common association type, such as contractual rights having a similar risk of default. By way of example, if there are at least two contractual rights, a first value may be assigned to the first contractual right, the first value defining a first risk of default associated with the first contractual right. In addition, a second value may be assigned to the second contractual right, the second value defining a second risk of default associated with the second contractual right. Preferably, the first value and the second value should fall within one of a number of predetermined ranges of values.

By way of example, the value defining a risk of default may fall between 0% and 100%, inclusive, and there may be a number of predetermined ranges of values falling between those percentages. A first predetermined range of values may fall between 0% and 10%, inclusive. A second predetermined range of values may fall between 11% and 20%, inclusive. A third predetermined range of values may fall between 21% and 30%, inclusive. A fourth predetermined range of values may fall between 31% and 40%, inclusive. A fifth predetermined range of values may fall between 41% and 50%, inclusive. A sixth predetermined range of values may fall between 51% and 60%, inclusive. A seventh predetermined range of values may fall between 61% and 70%, inclusive. An eighth predetermined range of values may fall between 71% and 80%, inclusive. A ninth predetermined range of values may fall between 81% and 90%, inclusive. A tenth predetermined range of values may fall between 91% and 100%, inclusive. Preferably, the aforementioned first and second values will fall in one of the above-specified predetermined ranges of values, such that the first and second contractual rights have a similar risk of default. The predetermined ranges mentioned above might each encompass a different range of values.

In view of the foregoing, it may be preferable from the third entity's point of view to have the entire list be dedicated to contractual rights having a common association type, such as contractual rights having a similar risk of default. Alternatively, the list may be segmented such that a section of the list comprises only contractual rights having a common association type, such as contractual rights each having a risk of default that falls within a predetermined range of values defining risks of default.

The embodiment described in connection with FIG. 4A is well suited to electronic commerce. In this regard, the aforementioned request to assist with a transaction involving a first intellectual property asset from a first entity may be an electronic request. By way of example, the electronic request may be made using an e-mail or by a telephone call for example. In addition, the transaction may be implemented as an electronic contract between the first entity (e.g., a licensor) and a second entity (e.g., a licensee). An electronic contract is a contract created wholly or in part through communications over computer networks. In this regard, contracts can be created, for example, by e-mail, through web sites, or through electronic data interchanges.

The transaction may also be implemented as an electronic data interchange transaction. An electronic data interchange transaction is one in which there is an online exchange of a routine business transaction in a computer-processable format. In an electronic data interchange transaction, data is exchanged directly between computers, utilizing standard formats, so that the data can be implemented directly by the receiving computer.

Preferably, the assisting entity (e.g., broker) facilitating the licensing of the first intellectual property asset to a second entity is implemented on a vehicle of electronic commerce. By way of example, the vehicle of electronic commerce may be a web site or an online facility implemented by a commercial online service such as America Online.

FIG. 4B is a flow chart depicting the steps of a method of acquiring contractual rights to receive payments resulting from the transfer of rights in intellectual property assets in accordance with another embodiment, which may be at least partially implemented in software.

In step 415, the third entity accesses a first list (such as the one identified in connection with step 410) identifying a first group of contractual rights to receive royalty payments including at least the first contractual right to receive at least a first royalty payment (or multiple royalty payments) that was received in exchange for the transfer of interest(s) in at least one or more intellectual property assets. The first group of contractual rights to receive royalty payments may also include a second contractual right to receive at least a second royalty payment based on the licensing of a second intellectual property asset.

Although a contractual right may have been received in exchange for the transfer of an interest in a single intellectual property asset, it is also contemplated that a contractual right may have been received in exchange for the transfer(s) of interest(s) in multiple intellectual property assets.

In step 420, the third entity (or another entity for whom the third entity identified the contractual right) acquires a transferable interest in the contractual right to receive at least the first royalty payment. The transferable interest in the contractual right may be acquired along with a security interest in one or more intellectual property assets. However, the transferable interest in the contractual right may be made available for transfer apart from any rights associated with intellectual property asset(s) except for a security interest in one or more of the intellectual property assets.

In step 425, the third entity may transfer the first contractual right to a special purpose vehicle to facilitate the issuance of securities backed by at least the first contractual right to receive at least the first royalty payment resulting from the licensing of the intellectual property asset. In this way, the special purpose vehicle may directly issue the securities backed by the first contractual right or may do so through another entity, such as a trust. The securities may also be backed by the second contractual right to receive at least a second royalty payment resulting from the licensing of the second intellectual property asset.

The first royalty payment may be made using an electronic finds transfer. The first royalty payment may be serviced by an entity other than the special purpose vehicle. By way of example, a broker may service the first royalty payment.

A first entity may have a controlling interest in the first intellectual property asset and the second intellectual property asset. Alternatively, another entity may have a controlling interest in the second intellectual property asset. A controlling interest may be an ownership interest derived, for example, from having been assigned rights in the intellectual property asset. Alternatively, a controlling interest may be derived from having licensed the intellectual property asset. For example, the controlling interest may permit the first entity to sub-license the intellectual property asset.

If the first entity is in bankruptcy, the first entity may both license the intellectual property and subsequently derive a cash payment from the third entity in exchange for the transfer of the contractual rights, such that the creditors of the bankrupt company may be paid from the sale of the contractual right to receive at least a first royalty payment to the third entity.

With regard to the issuance of securities backed by multiple contractual rights to receive royalty payments (e.g., a first contractual right to receive a first royalty payment and a second contractual right to receive a second royalty payment), it may be attractive from an investor's point of view to invest in securities backed by intellectual property assets associated with a particular type of product or service because the investor may have a keen understanding of those products, thereby allowing the investor to more readily gauge the commercial risks associated with an investment in those securities.

By way of example, the intellectual property assets may be associated with computer peripherals (e.g., disk drives). As a result, the value of the securities backed by multiple contractual rights to receive royalty payments resulting from the licensing of intellectual property assets associated with computer peripherals would likely reflect the success of those products in commerce. The risk that royalty payments may decrease is directly linked to the success of computer peripheral sales in commerce.

From an investors' point of view, it may also be preferable to invest in securities backed by multiple contractual rights to receive royalty payments resulting from the licensing of intellectual property assets associated with products and/or services sold in a particular industry or to a particular market segment. In this way, the risk that those royalty payments may decrease is directly linked to the success of those products and/or services in a particular industry or to a particular market segment.

An industry is made up of sellers who provide a particular type of product or service (e.g., computer peripherals), or a class of products or services (e.g., computer products). A market is made up of a group of buyers whose particular needs are addressed by an industry through the sale of a particular type of product or service or a class of products or services. A market segment is a subset of the group of buyers making up a market, the subset of that group of buyers having particular characteristics. By way of example, a market segment may include high-end buyers of computer peripherals, who seek the best computer peripherals that money can buy with the most advanced features. The reason for segmenting a market stems from the fact that the performance of a particular segment of a market may be superior to that of the market as a whole, and investors may find it advantageous to invest in intellectual property based asset backed securities associated with intellectual property assets employed in products or services associated with a particular market segment.

By way of example, if royalty payments are based on the sales of computer peripherals made by the computer peripheral industry, then the risk that royalty payments may decrease is directly linked to the success of the computer peripheral industry, as a whole. Similarly, if royalty payments are based on products sold to the market segment including buyers of high-end computer peripherals, then the risk that royalty payments may decrease is directly linked to the success of computer peripheral sales to that particular market segment.

It may also be preferable to invest in securities backed by multiple contractual rights to receive royalty payments resulting from the licensing of intellectual property assets, if the contractual rights have a similar risk of default. By way of example, if there are two intellectual property assets, a first value may be assigned to the first contractual right, the first value defining a first risk of default associated with the first contractual right. In addition, a second value may be assigned to the second contractual right, the second value defining a second risk of default associated with the second contractual right. Preferably, the first value and the second value should fall within a predetermined range of values.

By way of example, the value defining a risk of default may fall between 0% and 100%, inclusive, and there may be a number of predetermined ranges of values falling between those percentages. A first predetermined range of values may fall between 0% and 10%, inclusive. A second predetermined range of values may fall between 11% and 20%, inclusive. A third predetermined range of values may fall between 21% and 30%, inclusive. A fourth predetermined range of values may fall between 31% and 40%, inclusive. A fifth predetermined range of values may fall between 41% and 50%, inclusive. A sixth predetermined range of values may fall between 51% and 60%, inclusive. A seventh predetermined range of values may fall between 61% and 70%, inclusive. An eighth predetermined range of values may fall between 71% and 80%, inclusive. A ninth predetermined range of values may fall between 81% and 90%, inclusive. A tenth predetermined range of values may fall between 91% and 100%, inclusive. Preferably, the aforementioned first and second values will fall in one of the above-specified predetermined ranges of values, such that the first and second contractual rights have a similar risk of default. One of ordinary skill in the art would recognize that the predetermined ranges mentioned above may each encompass a different range of values.

The embodiment described in connection with FIG. 4B is well suited to electronic commerce. By way of example, the electronic list may be provided electronically via a vehicle of electronic commerce, such as a web site or an online facility implemented by a commercial online service such as America Online. In this manner, entities, such as the above-mentioned third entity may access or receive the electronic list via a computer network.

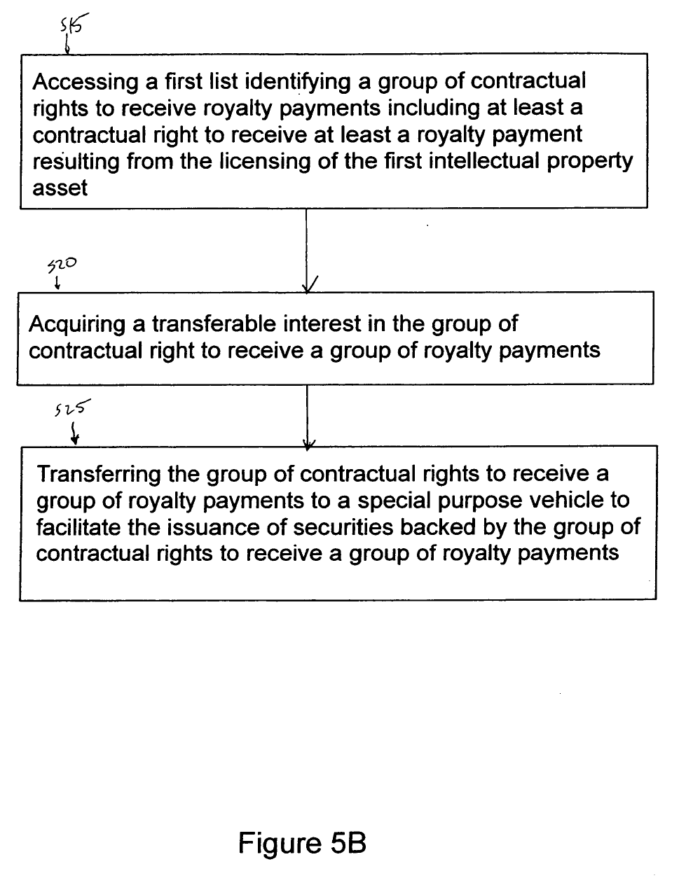

FIG. 5A is a flow chart depicting the steps of a method of facilitating transactions involving contractual rights to receive payments resulting from the transfer(s) of rights in intellectual property asset(s) in accordance with an embodiment.

In step 500, an assisting entity (e.g., broker) receives from a plurality of entities a corresponding plurality of requests to assist with transactions involving intellectual property assets. In step 505, the assisting entity assists with a group of the transactions involving the intellectual property assets. The group of transactions comprises the licensing of a group of the intellectual property assets, the licensing resulting in a group of the entities securing contractual rights to receive groups of royalty payments from at least one licensee (or multiple licensees). Each of the contractual rights is associated with one of the groups of royalty payments and each of the groups of royalty payments comprises at least one royalty payment or multiple royalty payments.

Thereafter, in step 510, the assisting entity provides a group of entities including a third entity with access to a list identifying a group of the contractual rights from the group of entities who secured the contractual rights from one or more licensees. For each contractual right identified in the list, a transferable interest in that contractual right is made available for transfer (e.g., purchase) to a receiving entity.

Advantageously, the transferable interest in some or all of the contractual rights is made available for transfer apart from any rights associated with intellectual property assets except a security interest in the intellectual property asset. In this way, the entities (e.g., the second entity) that receive transferable interests in the intellectual property assets that were exchanged for the contractual rights to receive payments can retain those interests unimpeded if the payments are made.

As noted above, it may be attractive from the third entity's point of view to identify and/or acquire contractual rights having a common association type or to identify and/or acquire contractual rights whose value is based on intellectual property assets having a common association type. The entire list may be dedicated to contractual rights having a common association type or to contractual rights associated with intellectual property assets having a common association type. As an alternative, the list may be segmented such that a section of the list comprises only contractual rights having a common association type, or comprises only contractual rights associated with intellectual property assets having a common association type

An example of a group of intellectual property assets having a common association type is a group of intellectual property assets associated with a particular type of product or service, associated with combination of related product(s) and service(s), associated with a particular type of product or service sold in a particular industry or sold to a particular market segment, or associated with a combination of related product(s) and service(s) sold in a particular industry or sold to a particular market segment. An example of a group of contractual rights having a common association type is a group of contractual rights having similar risks of default.

The embodiment described in connection with FIG. 5A is well suited to electronic commerce. In this regard, the aforementioned requests to assist with transactions involving intellectual property assets from a plurality of entities may be electronic requests. By way of example, the electronic requests may be made using e-mails or by telephone. In addition, the transactions may be implemented as electronic contracts between the plurality of entities (e.g., licensors) and at least one licensee. An electronic contract is a contract created wholly or in part through communications over computer networks. In this regard, contracts can be created, for example, by e-mail, through web sites, or through electronic data interchanges.

The transactions may also be implemented as electronic data interchange transactions. An electronic data interchange transaction is one in which there is an online exchange of a routine business transaction in a computer-processable format. In an electronic data interchange transaction, data is exchanged directly between computers, utilizing standard formats, so that the data can be implemented directly by the receiving computer.

Preferably, the assisting entity assists with the licensing of the first intellectual property asset using a vehicle of electronic commerce. By way of example, the vehicle of electronic commerce may be a web site or an online facility implemented by a commercial online service such as America Online.

FIG. 5B is a flow chart depicting the steps of a method of acquiring contractual rights to receive payments resulting from the transfer of rights in intellectual property assets in accordance with another embodiment.

In step 515, the third entity accesses a first list (such as the one identified in connection with step 510) identifying a first group of contractual rights to receive royalty payments including multiple contractual rights, with each contractual right being a contractual right to receive at least a first royalty payment (or multiple royalty payments) that was received in exchange for the transfer of an interest in at least one or more intellectual property assets. By way of example, the first group of contractual rights to receive royalty payments may include a first contractual right to receive at least a first royalty payment based on the licensing of a first intellectual property asset and a second contractual right to receive at least a second royalty payment based on the licensing of a second intellectual property asset.

Although a contractual right may have been received in exchange for the transfer of an interest in a single intellectual property asset, it is also contemplated that contractual rights may have been received in exchange for the transfer(s) of interest(s) in multiple intellectual property assets.

In step 520, the third entity (or another entity for whom the third entity identified the contractual right) acquires transferable interests in the group of contractual rights to receive royalty payments. The transferable interest in each of the contractual rights may be acquired along with a security interest in the one or more intellectual property assets. The transferable interest in each of the contractual rights may be acquired apart from any other interest in intellectual property assets except for a security interest in one or more of the intellectual property assets.

In step 525, the third entity may transfer the group of contractual rights to a special purpose vehicle to facilitate the issuance of securities backed by the group of contractual rights resulting from the licensing of the group of intellectual property assets. By transferring the group of contractual rights to the special purpose vehicle, the special purpose vehicle may directly issue the securities backed by the group of contractual rights or may do so through another entity, such as a trust.

Advantageously, if one of the plurality of entities is in bankruptcy, that entity may both license an intellectual property asset and derive a cash payment from an assisting entity (such as a broker) practicing certain exemplary embodiments, such that the creditors of the bankrupt company may be paid from the sale of the contractual right to receive a group of royalty payments to the broker.

With regard to the issuance of securities backed by multiple contractual rights to receive groups of royalty payments, it may be attractive from an investors point of view to invest in securities backed by intellectual property assets associated with a particular type of product or service because the investor may have a keen understanding of those products, thereby allowing the investor to more readily gauge the commercial risks associated with an investment in those securities.

From an investor's point of view, it may also be preferable to invest in securities backed by multiple contractual rights to receive groups of royalty payments resulting from the licensing of intellectual property assets associated with products and/or services sold in a particular industry or to a particular market segment. In this way, the risk that those royalty payments may decrease is directly linked to the success of those products and/or services in a particular industry or to a particular market segment.

It may also be preferable to invest in securities backed by multiple contractual rights to receive groups of royalty payments resulting from the licensing of intellectual property assets, if the group of contractual rights has a similar risk of default. By way of example, risk values may be assigned to the group of contractual rights with each of the risk values defining a risk of default associated with a corresponding one of the group of contractual rights. Preferably, all of the risk values associated with the group of contractual rights should fall within a predetermined range of risk values.

The embodiment described in connection with FIG. 5B is well suited to electronic commerce. By way of example, the electronic list may be provided electronically via a vehicle of electronic commerce, such as a web site or an online facility implemented by a commercial online service such as America Online. In this manner, entities (such as the above-mentioned third entity) may access or receive the electronic list via a computer network.

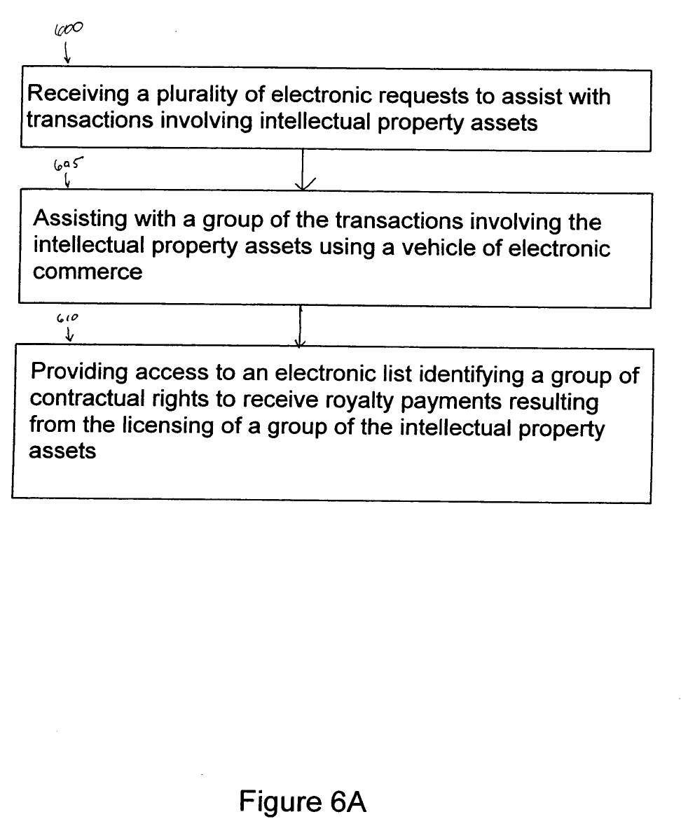

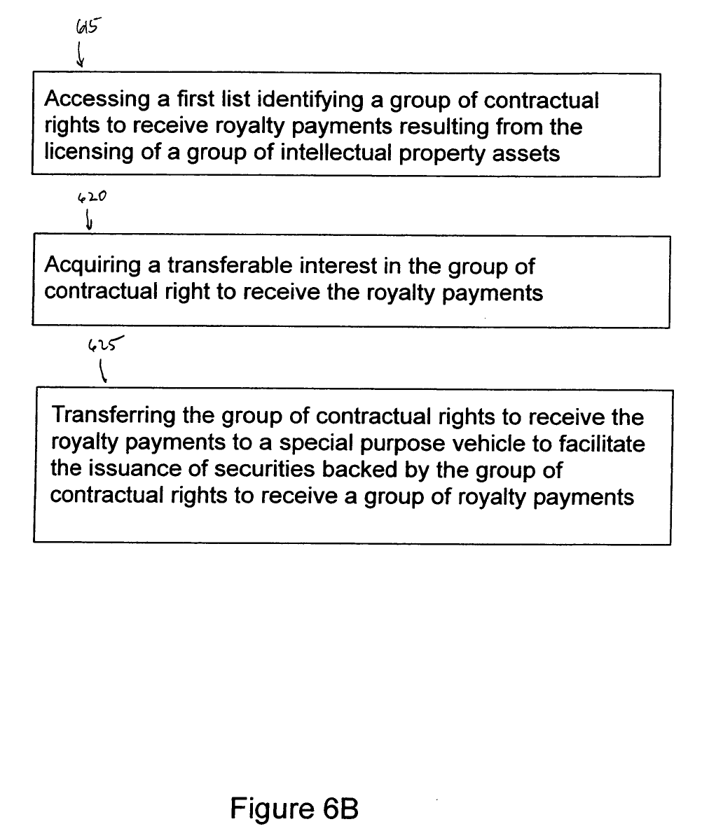

FIG. 6A is a flow chart depicting the steps of a method of facilitating transactions involving contractual rights to receive payments resulting from the transfer of rights in intellectual property assets in accordance with an embodiment, which may be at least partially implemented in software.

In step 600, an assisting entity (e.g., broker) receives electronic requests to assist with transactions involving intellectual property assets from a number of entities. The aforementioned electronic requests to broker transactions involving intellectual property assets from a number of entities may be made using e-mails or by postings to a vehicle of electronic commerce. By way of example, the vehicle of electronic commerce may be a web site or an online facility implemented by a commercial online service such as America Online.

In step 605, the assisting entity assists with the transactions involving the intellectual property assets using a vehicle of electronic commerce. The transactions may be implemented as electronic contracts between the entities (e.g., licensors and one or more licensees). The transactions may also be implemented as electronic data interchange transactions.

The transactions may include the licensing of a group of the intellectual property assets, the licensing resulting in a group of the entities securing a group of contractual rights to receive royalty payments from at least one or more licensees. Each of the contractual rights is associated with at least one of the royalty payments.

Thereafter, in step 610, the assisting entity provides a third entity with access to an electronic list identifying the group of the contractual rights from the group of entities who secured the contractual rights from, for example, one or more licensees. For each contractual right identified in the list, a transferable interest in that contractual right is being made available for transfer (e.g., purchase) to a receiving entity.

Advantageously, the transferable interest in some or all of the contractual rights is made available for transfer apart from any rights associated with intellectual property assets except a security interest in one or more intellectual property asset. In this way, the entities (e.g., the second entity) that receive transferable interests in the intellectual property assets that were exchanged for the contractual rights to receive one or more payments can retain those interests unimpeded if the payments are made.

As noted above, it may be attractive from the third entity's point of view to identify and/or acquire contractual rights having a common association type or to identify and/or acquire contractual rights whose value is based on intellectual property assets having a common association type. The entire list may be dedicated to contractual rights having a common association type or to contractual rights associated with intellectual property assets having a common association type. As an alternative, the list may be segmented such that a section of the list comprises only contractual rights having a common association type, or comprises only contractual rights associated with intellectual property assets having a common association type

An example a group of intellectual property assets having a common association type is a group of intellectual property assets associated with a particular type of product or service, associated with combination of related product(s) and service(s), associated with a particular type of product or service sold in a particular industry or sold to a particular market segment, or associated with a combination of related product(s) and service(s) sold in a particular industry or sold to a particular market segment. An example of a group of contractual rights having a common association type is a group of contractual rights having similar risks of default.

FIG. 6B is a flow chart depicting the steps of a method of acquiring contractual rights to receive payments resulting from the transfer of rights in intellectual property assets in accordance with another embodiment.

In step 615, the third entity accesses a first list (such as the one identified in connection with step 610) identifying a first group of contractual rights to receive royalty payments including multiple contractual rights, with each contractual right being a contractual right to receive at least a first royalty payment (or multiple royalty payments) that was received in exchange for the transfer of an interest in at least one or more intellectual property assets. By way of example, the first group of contractual rights to receive royalty payments may include a first contractual right to receive at least a first royalty payment based on the licensing of a first intellectual property asset and a second contractual right to receive at least a second royalty payment based on the licensing of a second intellectual property asset.

Although a contractual right may have been received in exchange for the transfer of an interest in a single intellectual property asset, it is also contemplated that a contractual right may have been received in exchange for the transfer(s) of interest(s) in multiple intellectual property assets.

In step 620, the third entity (or another entity for whom the third entity identified the contractual right) acquires transferable interests in one or more contractual rights of the group of contractual rights to receive one or more royalty payments (including future royalty payments). The transferable interest in each of the contractual rights may be acquired along with a security interest in the one or more intellectual property assets. The transferable interest in some or all of the contractual rights is made available for transfer apart from any rights associated with intellectual property assets except a security interest in one or more intellectual property assets.

In step 625, the third entity may transfer the group of contractual rights to a special purpose vehicle to facilitate the issuance of securities backed by the group of the contractual rights resulting from the licensing of the group of the intellectual property assets. By transferring the group of contractual rights to the special purpose vehicle, the special purpose vehicle may directly issue the securities backed by the group of contractual rights or may do so through another entity, such as a trust.

Advantageously, if one of the plurality of entities is in bankruptcy, that entity may both license an intellectual property asset and derive a cash payment from an assisting entity (such as a broker) practicing certain exemplary embodiments, such that the creditors of the bankrupt company may be paid from the sale of the contractual right to receive a group of royalty payments to the broker.

With regard to the issuance of securities backed by multiple contractual rights to receive groups of royalty payments, it may be attractive from an investor's point of view to invest in securities backed by intellectual property assets associated with a particular type of product or service because the investor may have a keen understanding of those products, thereby allowing the investor to more readily gauge the commercial risks associated with an investment in those securities.

From an investor's point of view, it may also be preferable to invest in securities backed by multiple contractual rights to receive groups of royalty payments resulting from the licensing of intellectual property assets associated with products and/or services sold in a particular industry or to a particular market segment. In this way, the risk that those royalty payments may decrease is directly linked to the success of those products and/or services in a particular industry or to a particular market segment.

It may also be preferable to invest in securities backed by multiple contractual rights to receive groups of royalty payments resulting from the licensing of intellectual property assets, if the group of contractual rights has a similar risk of default. By way of example, risk values may be assigned to the group of contractual rights with each of the risk values defining a risk of default associated with a corresponding one of the group of contractual rights. Preferably, all of the risk values associated with the group of contractual rights should fall within a predetermined range of risk values.

It is preferable that the royalty payments are made using electronic funds transfers. The royalty payments may be serviced by an entity other than the special purpose vehicle. By way of example, the assisting entity may service the royalty payments.

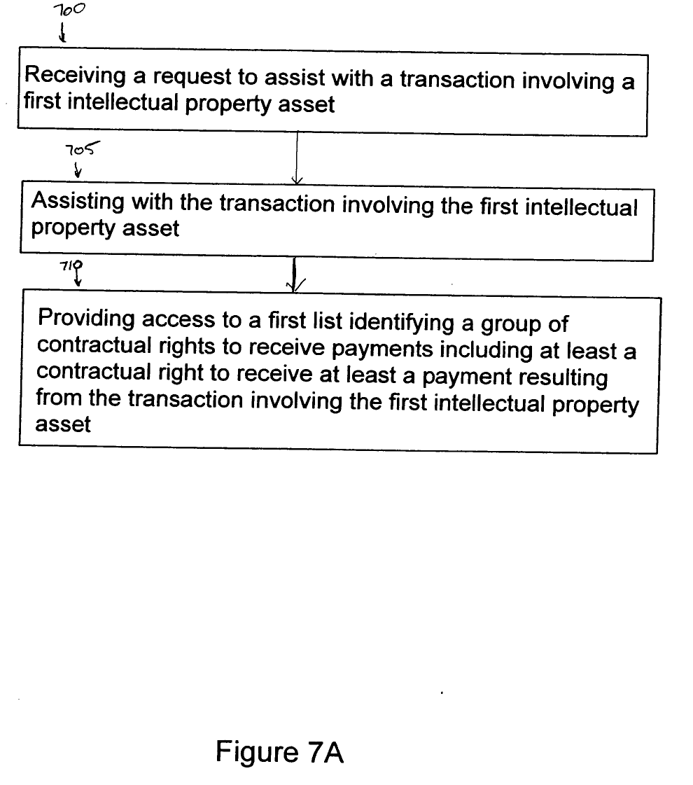

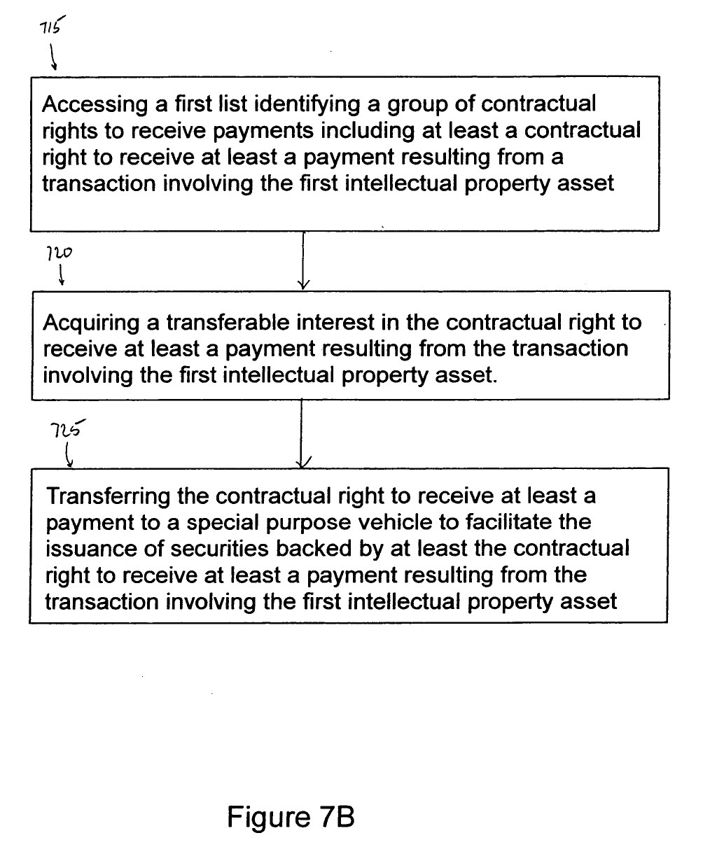

FIG. 7A is a flow chart depicting the steps of a method of facilitating transactions involving contractual rights to receive payments resulting from the transfer of rights in intellectual property assets in accordance with certain exemplary embodiments.

In step 700, an assisting entity (e.g., broker) receives a request (or requests) to assist with a transaction (or transactions) involving an intellectual property asset (or intellectual property assets) from a first entity (or multiple entities). In step 705, the assisting entity assists with the transaction (or transactions) involving the intellectual property asset (or intellectual property assets), the transaction resulting in the first entity securing a first contractual right to receive at least a first payment (or multiple payments) from a second entity (or multiple entities) in exchange for an interest in one or more intellectual property assets.

By way of example, the transaction (or transactions) may include the licensing, leasing or sale of an intellectual property asset. The leasing of an intellectual property asset involves a contract between, for example, the first entity (i.e., the lessor) and the second entity (i.e., the lessee). The first entity agrees to allow the second entity to utilize the intellectual property asset for a stated period of time in exchange for a specified schedule of payments (e.g., fixed payments).

In step 710, the assisting entity provides a third entity with access to a first list identifying a first group of contractual rights to receive payments in exchange for the transfer(s) of interest(s) in one or more intellectual property assets, the first group of contractual rights including at least the first contractual right to receive a first payment (or multiple payments).

For each contractual right in the first group of contractual rights that is identified in the list, a transferable interest in that contractual right is being made available for transfer (e.g., purchase) to a receiving entity. The contractual right may be made available for transfer to a receiving entity along with a security interest in one or more intellectual property assets. The transferable interest(s) in some or all of the contractual rights in the first group are made available for transfer apart from any rights associated with intellectual property assets except a security interest in one or more intellectual property assets. In this way, the entities (e.g., the second entity) that receive transferable interests in the intellectual property assets that were exchanged for the contractual rights to receive payments can retain those interests unimpeded if the payments are made.

The first group of contractual rights to receive royalty payments may also include a second contractual right to receive at least a second royalty payment (or multiple royalty payments) based on the transfer of an interest in a second intellectual property asset.

Although a contractual right may have been received in exchange for the transfer of an interest in a single intellectual property asset, it is also contemplated that a contractual right may have been received in exchange for the transfer of an interest in multiple intellectual property assets.

As noted above, it may be attractive from the third entity's point of view to identify and/or acquire contractual rights having a common association type or to identify and/or acquire contractual rights whose value is based on intellectual property assets having a common association type. The entire list may be dedicated to contractual rights having a common association type or to contractual rights associated with intellectual property assets having a common association type. As an alternative, the list may be segmented such that a section of the list comprises only contractual rights having a common association type, or comprises only contractual rights associated with intellectual property assets having a common association type.

An example a group of intellectual property assets having a common association type is a group of intellectual property assets associated with a particular type of product or service, associated with combination of related product(s) and service(s), associated with a particular type of product or service sold in a particular industry or sold to a particular market segment, or associated with a combination of related product(s) and service(s) sold in a particular industry or sold to a particular market segment. An example of a group of contractual rights having a common association type is a group of contractual rights having similar risks of default.

The embodiment described in connection with FIG. 7A is well suited to electronic commerce. In this regard, the aforementioned request to assist with a transaction involving an intellectual property asset from a plurality of entities may be electronic requests. By way of example, the electronic requests may be made using e-mails or by telephone. In addition, the transactions may be implemented as electronic contracts between the plurality of entities (e.g., licensors) and the second entity (e.g., licensee). An electronic contract is a contract created wholly or in part through communications over computer networks. In this regard, contracts can be created, for example, by e-mail, through web sites, or through electronic data interchanges.

The transactions may also be implemented as electronic data interchange transactions. An electronic data interchange transaction is one in which there is an online exchange of a routine business transaction in a computer-processable format. In an electronic data interchange transaction, data is exchanged directly between computers, utilizing standard formats, so that the data can be implemented directly by the receiving computer.

Preferably, the assisting entity assists with the licensing of the first intellectual property asset using a vehicle of electronic commerce. By way of example, the vehicle of electronic commerce may be a web site or an online facility implemented by a commercial online service such as America Online.

FIG. 7B is a flow chart depicting the steps of a method of acquiring contractual rights to receive payments resulting from the transfer(s) of rights in intellectual property assets in accordance with another exemplary embodiment.

In step 715, the third entity accesses a first list (such as the one identified in connection with step 710) identifying a first group of contractual rights to receive payments in exchange for the transfer(s) of interest(s) in one or more intellectual property assets, the first group of contractual rights including at least a first contractual right to receive at least a first payment or multiple payments, the payment(s) being received in exchange for the transfer of an interest in at least one or more intellectual property assets. These payment(s) include at least a future payment. The first group of contractual rights to receive payments may also include a second contractual right to receive at least a second payment based on the licensing of a second intellectual property asset.

By way of example, the transfer of an interest in the intellectual property asset may include the licensing, leasing or sale of an intellectual property asset. The leasing of an intellectual property asset involves a contract between, for example, the first entity (i.e., the lessor) and the second entity (i.e., the lessee). The first entity agrees to allow the second entity to utilize the intellectual property asset for a stated period of time in exchange for a specified schedule of payments.

Although a contractual right may have been received in exchange for the transfer of an interest in a single intellectual property asset, it is also contemplated that a contractual right may have been received in exchange for the transfer of an interest in multiple intellectual property assets.

In step 720, the third entity (or another entity for whom the third entity identified the contractual right) acquires a transferable interest in the contractual right to receive at least the first payment (or multiple payments) resulting from the transfer of an interest in one or more intellectual property assets. The transferable interest in the contractual right may be acquired along with a security interest in the one or more intellectual property assets. The transferable interest in the contractual right may be acquired apart from any other interest in intellectual property assets except for a security interest in one or more of the intellectual property assets.

Although the third entity has been described as acquiring a transferable interest in single contractual right, the third entity may acquire transferable interests in multiple contractual rights to receive one or more payments that have been received in exchange for transfer(s) of interest(s) in one or more intellectual property assets.

In step 725, the third entity may transfer the acquired transferable interest in at least the first contractual right (or multiple contractual rights) to a special purpose vehicle to facilitate the issuance of securities backed by at least the first contractual right to receive at least the first payment resulting from the transfer of an interest in the intellectual property asset. In this way, the special purpose vehicle may directly issue the securities backed by the first contractual right or may do so through another entity, such as a trust. The securities may also be backed by a second contractual right (acquired by the third entity) to receive at least a second payment resulting from the transfer of an interest in a second intellectual property asset.

The first payment (as well as other payments made by the second entity) may be made using an electronic funds transfer. The first payment may be serviced by an entity other than the special purpose vehicle. By way of example, an assisting entity (e.g., servicing agent, broker) may service the first royalty payment.

The first entity may have a controlling interest in the first intellectual property asset and the second intellectual property asset. Alternatively, a second entity may have a controlling interest in the second intellectual property asset. The controlling interest may be an ownership interest derived, for example, from having been assigned rights in the intellectual property asset. Alternatively, the controlling interest may be derived from having licensed the intellectual property asset. The controlling interest may permit the first entity to sub-license the intellectual property asset.

If the first entity is in bankruptcy, the first entity may both license the intellectual property and derive a cash payment from the third entity, such that the creditors of the bankrupt company may be paid from the sale of the contractual right to receive at least a first royalty payment to the third entity.

With regard to the issuance of securities backed by multiple contractual rights to receive payments in exchange for the transfer(s) of interest(s) in intellectual property assets (e.g., a first contractual right to receive a first payment and a second contractual right to receive a second royalty payment), it may be attractive from an investor's point of view to invest in securities backed by intellectual property assets associated with a particular type of product or service because the investor may have a keen understanding of those products, thereby allowing the investor to more readily gauge the commercial risks associated with an investment in those securities.

From an investors' point of view, it may also be preferable to invest in securities backed by multiple contractual rights to receive royalty payments resulting from the licensing of intellectual property assets associated with products and/or services sold in a particular industry or to a particular market segment. In this way, the risk that those royalty payments may decrease is directly linked to the success of those products and/or services in a particular industry or to a particular market segment.

It may also be preferable to invest in securities backed by multiple contractual rights to receive royalty payments resulting from the licensing of intellectual property assets, if the contractual rights have a similar risk of default. By way of example, if there are two intellectual property assets, a first value may be assigned to the first contractual right, the first value defining a first risk of default associated with the first contractual right. In addition, a second value may be assigned to the second contractual right, the second value defining a second risk of default associated with the second contractual right. Preferably, the first value and the second value should fall within a predetermined range of values.

By way of example, the value defining a risk of default may fall between 0% and 100%, inclusive, and there may be a number of predetermined ranges of values falling between those percentages. A first predetermined range of values may fall between 0% and 10%, inclusive. A second predetermined range of values may fall between 11% and 20%, inclusive. A third predetermined range of values may fall between 21% and 30%, inclusive. A fourth predetermined range of values may fall between 31% and 40%, inclusive. A fifth predetermined range of values may fall between 41% and 50%, inclusive. A sixth predetermined range of values may fall between 51% and 60%, inclusive. A seventh predetermined range of values may fall between 61% and 70%, inclusive. An eighth predetermined range of values may fall between 71% and 80%, inclusive. A ninth predetermined range of values may fall between 81% and 90%, inclusive. A tenth predetermined range of values may fall between 91% and 100%, inclusive. Preferably, the aforementioned first and second values will fall in one of the above-specified predetermined ranges of values, such that the first and second contractual rights have a similar risk of default. One of ordinary skill in the art would recognize that the predetermined ranges mentioned above may each encompass a different range of values.

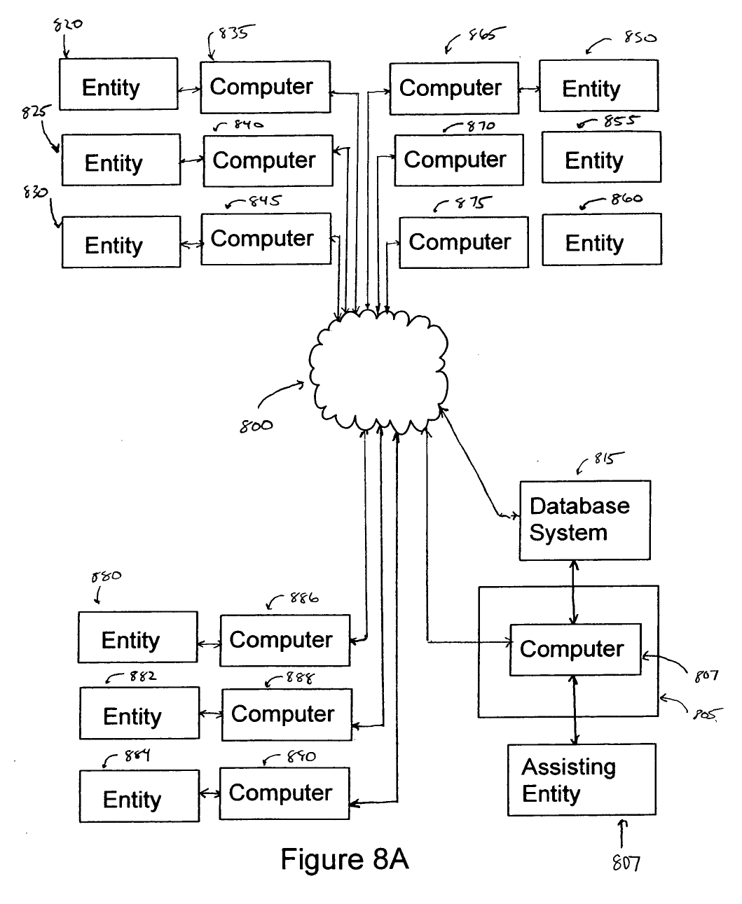

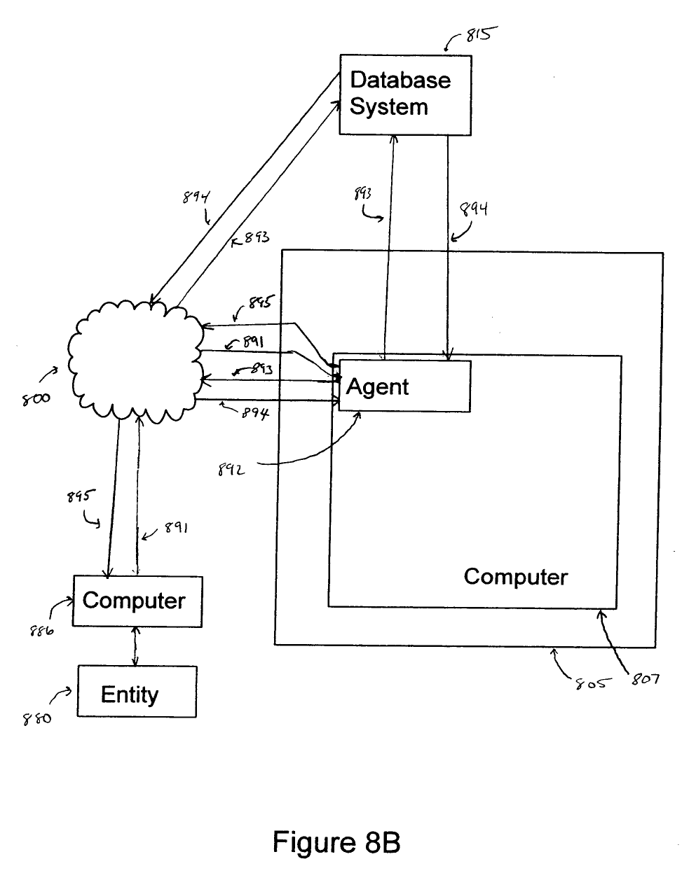

FIG. 8A depicts a network environment in which certain exemplary embodiments may be implemented. The network environment may include one or more networks, such as a local area network, a wide area network, wireless network and/or a public network (e.g., the Internet). A computer system 805 may include one (such as computer 807) or more computers connected via a network 800.

Each such computer may be a desktop, laptop, PDA, cellular phone or other such device. The computer is provided with a communication interface for two-way communication that provides the computer with a physical and/or wireless network connection to implement certain exemplary embodiments. The communication interface may be coupled to the processor via one or more buses. Examples of communication interfaces include a modem (analog or digital), LAN card, or an ISDN card.

The communication interface provides a link to one or more networks. By way of example, the communication interface may enable a connection to a remote computer via, for example, equipment operated by an Internet Service Provider. The Internet Service Provider in turn provides data communication services through the worldwide packet data communication network referred to as the Internet.

Each computer has one or more processors for processing information that is coupled to one or more memory storage devices via one or more buses. The memory storage devices may be used for storing information and instructions to be executed by the processor(s). The memory storage devices may include dynamic storage device(s) and/or static storage device(s). Examples of such memory storage devices include a RAM, ROM, flash memory, magnetic disk, optical disk, or a redundant array of independent drives (RAID). The computer may be coupled to the storage device(s) via a local area network, wide area network or public network (e.g., the Internet).

The memory storage device(s) coupled to the processor(s) of the computer may also store data including information relating to a requested transaction and/or a completed transaction involving the transfer of an interest in one or more intellectual property assets. The storage device(s) may also store programs and/or data including information relating to contractual rights to receive one or more payments (including future payments) in exchange for the transfer of an interest in one or more intellectual property assets.

Each computer of the computer system 805 may also be provided with a display, such as a CRT, LCD, plasma or other such display, as well as input devices, such as a keyboard, mouse and/or trackball for entering information by a user. The display and input devices are coupled to the processor(s) via one or more buses.

A computer-readable medium comprises any medium that provides instructions to a processor for execution such as non-volatile media, volatile media and transmission media. Examples of a computer-readable medium include the memory storage devices discussed above, as well as transmission media such as electromagnetic waves, such as those generated during radio wave and infrared data communications. Computer-readable media may also include a floppy disk, magnetic medium (such as a hard disk), CD-ROM, RAM, PROM, EPROM, FLASH-EPROM or any other memory chip or cartridge.

Various forms of computer readable media may be involved in carrying one or more sequences of one or more instructions to a processor for execution. The remote computer (e.g., server or peer) can load the instructions into its dynamic memory and send the instructions over a network to a local computer (e.g., client or peer). The local computer's communication interface receives the instructions and provides them to the processor(s) of the local computer via one or more buses for execution.

The computer system 805 may be operated by, for example, an assisting entity 807, such as a broker, which may be an individual or a business entity, such as a partnership (general or limited), corporation, limited liability partnership, or limited liability company.

The computer system 805 may be implemented as a vehicle of electronic commerce. By way of example the computer system 805 may include one or more web servers supporting a web site. The computer system 805 may also be implemented an online facility maintained by a commercial online service (e.g., America Online).

The computer system 805 is employed to receive and process electronic requests to assist with (e.g., broker) transactions involving intellectual property assets and to facilitate the transaction in the manner described above. The computer system 805 is also employed to provide an electronic list including one or more contractual rights that are received in exchange for transfer(s) of interest(s) in one or more intellectual property assets, as described above.

According to certain exemplary embodiments, a transferable interest in one or more contractual rights to receive one or more payments (including at least a future payment) received in exchange for the transfer(s) of interest(s) in one or more intellectual property assets are made available for transfer (e.g., offered for sale) to those who receive access to the list via the network. By way of example, if the computer system 805 comprises a web server that supports a web site, the electronic list may be posted to the web site such that individuals having, for example, web browsers may access the list via the network 800 if the computers they are on have access to the network. Such individuals may also receive access to the electronic list by way of email or instant messaging.

The computer system 805 may be coupled to the database system 815 via, for example, the network 800 or another network, or the computer system 805 and the database system 815 may reside within the same computer system (not shown). The database system 815 comprises one or more databases (e.g., relational databases) that may include records of information relating to a requested transaction and/or a completed transaction involving the transfer of an interest in one or more intellectual property assets. The database(s) of the database system 815 may also include records of information relating to contractual rights to receive one or more payments (including future payments) in exchange for the transfer of an interest in one or more intellectual property assets. The records of the database system 815 may be stored in one or more storage devices, such as the storage device(s) coupled to the computer system 805, as mentioned above.

Although described as separate systems, the computer system 805 and the database system 815 may be integrated onto a single computer. However, it may be more practical to have the database system 815 implemented as a separate database server.

The database system 815 is managed by database management software (not shown), which manages requests to access, update or delete information from the database. The database management software may reside on the computer system 805 or the above-mentioned database server (not shown). The database management software may also provide additional data-related services such as sorting or filtering of data information stored in the database system 815.

As noted above, the computer system 805 may include a one or more computers (such as computer 807) and at least one of those computers may include a web server through which an entity employing a web browser may query the database system 815, which may be a database server. The database system 815 may be queried via the database management software residing on the computer system 805 or a database server that is part of the database system 815. Alternatively, the database manger may have a graphical user interface for querying the database that does not rely on the use of a web browser.

A number of entities 820, 825 and 830 may interact with the computer system 805 via computers 835, 840 and 845 each having a display. If any of the computers 835, 840 and 845 is operated by an entity, other than an individual, such as a trust, partnership (general or limited), corporation, limited liability partnership, or limited liability company, then a representative of that entity may operate the computer 835, 840 or 845.

Each of the entities 820, 825 and 830 may submit an electronic request to the computer system 805 (via corresponding computers 835, 840 and 845) to assist with a transaction involving one or more intellectual property assets, and the information received as part of the electronic requests is stored in records (such as the first record 900 described below) which are part of the database(s) included in the database system 815. That information may, for example, include the identity of those intellectual property asset(s) and the type of transaction sought in connection with the intellectual property asset(s) and the terms of that transaction. The information may also include the identity of the entities 820, 825 and 830, as well as contact information. These records may be searchable using a query language, such as SQL.

If a particular transaction involves the licensing of an intellectual property asset, then the record will reflect the nature of the intellectual property asset, the type of license (i.e., exclusive or non-exclusive) sought for the intellectual property asset, and the terms associated with the license. The terms associated with the license will include at least the duration of the license, the minimum royalty rate (fixed or variable) sought by the licensor, the number of royalty payments, the periodicity of those royalty payments (e.g., monthly, quarterly, or yearly), and any restrictions placed on the license (territorial or otherwise).

The electronic requests made by entities 820, 825 and 830 may be made in the form of an e-mail sent by computers 835, 840 and 845. If the computer system 805 is a web server, which supports a web site, then the electronic request may be processed by the computer system 805 via the web site. Preferably, each of the entities 820, 825 and 830 may access the web site via a web browser that resides on computers 835, 840 and 845. By way of example, each electronic request may be made using an electronic form posted on a web site. Similarly, the electronic request may be made using an electronic form posted at an online facility implemented by a commercial online service, such as America Online. Information concerning the transaction may be posted to the web site and stored as one or more records (such as the first record 900 described below) in the database system 815 via the database management software (not shown).

A number of other entities 850, 855 and 860 also interact with the computer system 805 via computers 865, 870 and 875. These entities 850, 855 and 860 may be interested in entering into a transaction involving intellectual property assets. If any of the entities 850, 855 and 860 are interested in entering into a transaction involving an intellectual property asset identified in one of the records, at least a portion of which is made accessible to them, then that entity 850, 855 or 860 may directly contact the entity 825, 830 or 835 that requested the transaction to negotiate and complete the transaction involving that intellectual property asset.

Preferably, the transaction is completed using the computer system 805. In particular, the computer system 805 receives over the network from at least one of the entities 850, 855 or 860 a first electronic offer (which may be in the form of an e-mail or submitted via a web browser on computers 865, 870 and 875 and processed through an electronic form posted on a web site or at an online facility implemented by a commercial online service) to enter into the transaction, and the computer system 805 determines whether the first electronic offer is a successful electronic offer based on a particular criterion or combination of criteria. If all of the entities 850, 855 or 860 submit electronic offers to enter into a transaction, then the most favorable offer for the entity 820, 825 and 830 that requested the transaction will be the successful offer.

The criteria for a transaction including the licensing of an intellectual property asset may include, for example, the royalty rate and/or the duration of the period over which the patent will be licensed. The criteria for a transaction including the sale of an intellectual property asset would include, for example, the price offered for the intellectual property asset and the interest rate associated with any periodic payments that are made for the intellectual property asset. The criteria for a transaction including the leasing of an intellectual property asset may include the number of periodic payments provided as well as the amount of each payment. One of ordinary skill in the art will appreciate that there are additional criteria associated with the licensing, leasing or sale of an intellectual property asset.

If the transaction involves the licensing of a patent and the criterion selected by the entity 820, 825 and 830 that requested the transaction is the royalty rate, then the offer providing the highest royalty rate would be the successful offer. The computer system 805 would evaluate the information submitted by each of the entities 850, 855 or 860 that would be stored as records in the database system to determine, in accordance with the criterion or criteria established by the entity 820, 825 and 830 that requested the transaction, which was the successful offer.

After determining the successful offer, the computer system 805 provides a first electronic acceptance notification (which may be made in the form of an e-mail, or posted on a web site or at an online facility implemented by a commercial online service), which indicates acceptance of the terms of the offer, to the entity 850, 855 or 860 that submitted the successful electronic offer, thereby creating a first electronic contract between the entity 820, 825 or 830 that requested the transaction and the entity 850, 855 or 860 that submitted the successful electronic offer. The first electronic contract results in the entity 825, 830 or 835 that requested the transaction receiving a first contractual right to receive at least one or more payments, including, for example, a future payment. A record (such as record 1000 described below) of the completed transaction is stored in a database of the database system 815.

The entity 820, 825 or 830 that secured a contract with one of the entities 850, 855 or 860 may seek to transfer an interest in the first contractual right to receive one or more payments in exchange for the transfer of an interest(s) in one or more intellectual property assets. The entity 820, 825 or 830 may contact an assisting entity to make a request to assist with the transfer of an interest in the first contractual right (or multiple such contractual rights). The assisting entity who assists with the transfer of an interest in an intellectual property asset may be the same or different from the assisting entity who assists with the transfer of an interest in contractual rights to receive one or more payments (including a future payment) in exchange for transfer(s) of interest(s) in intellectual property asset(s).

The request to assist with the transfer(s) of interest(s) in intellectual property asset(s) may be sent via an e-mail provided by the entity 820, 825 or 830 or may be entered directly by that entity 820, 825 or 830 via an electronic form provided through a web site or an online facility maintained by a commercial online service. Information from the request may be included in a record (such as the third record 1100) that is stored in the database system 815.

The computer system 805 provides entities 880, 882 and 884 with access (which may be provided via an e-mail or instant messaging, or provided via a web site or an online facility implemented by a commercial online service) via corresponding computers 886, 888 and 890 to an electronic list including a group of contractual rights including one or more contractual rights to receive one or more payments, such as one or more future payments. The contractual rights identified in the list were received in exchange for the transfer(s) of interest(s) in one or more intellectual property rights. A transferable interest in each contractual right identified in the electronic list is made available for transfer (e.g., purchase) to a receiving entity, as described above.

As noted above, the transferable interests in some or all of the contractual rights are each made available for transfer along with a security interest in one or more intellectual property assets. The transferable interests in some or all of the contractual rights are each made available for transfer apart from any rights associated with intellectual property assets except for a security interest in one or more of the intellectual property assets. In this way, the entities (e.g., one of the entities 850, 855 and 860) that received transferable interests in the intellectual property assets that were exchanged for the contractual rights to receive payments can retain those interests unimpeded if payments are made.

FIG. 8B provides an example of how one of the entities (e.g., 880) can be provided with access to the above-mentioned electronic list via the computer system 805, which in this example is a web server, and the database system 815, which in this example is a database server. This same technique may be used for the other entities 882 and 884. The entity 880 makes a request 891 via a web browser on the entity's computer 886 for access to information concerning contractual rights (i.e., contractual rights to receive one or more payments in exchange for interest(s) in one or more intellectual property assets), an interest, in each of which, is being made available for transfer. The entity 880 may provide as part of the request certain criterion or criteria relating to attributes of the contractual rights that the entity 880 is interested in acquiring interest(s) therein. Based on the request 891 (including, for example, the specified criterion or criteria), the web server invokes an agent 892 residing, for example, on the web server. The agent 892 passes 893 the request 891 or the information found in the request 891 (including the criteria or criterion) to the database server, which executes one or more queries based on the request 891, using, for example, a SQL procedure. Thereafter, the database server dynamically creates one or more HTML or XML based pages, which include(s) the results of the query or queries, and returns 894 the HTML or XML based page(s) to the agent 892. The web server completes the request by returning 895 the HTML or XML based page(s) to the web browser.

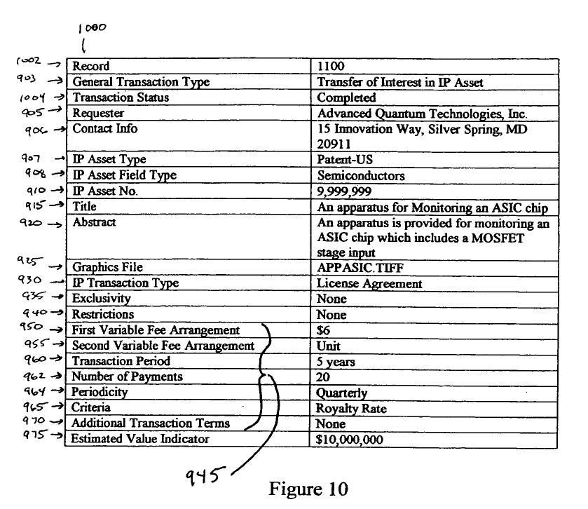

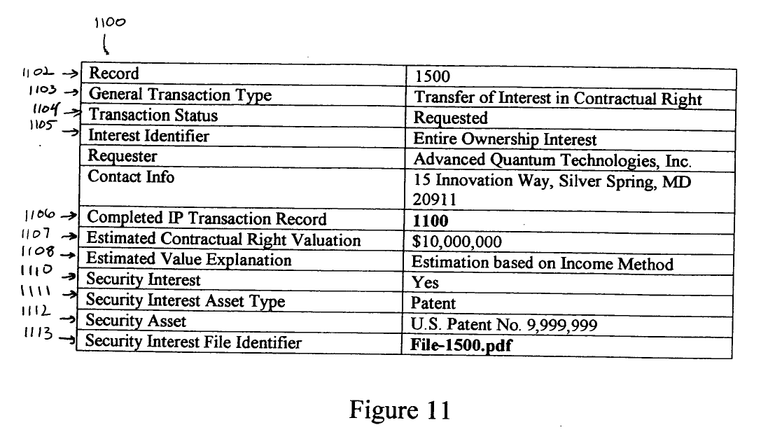

The above-mentioned criteria or criterion of request 891 may be specified, for example, as the value(s) of one or more fields corresponding to those identified in connection with the records of FIGS. 10 and 11 discussed below. Also, as noted above, it may be attractive from an entity's (e.g., 880) point of view to identify and/or acquire one or more contractual rights having a common association type or to identify and/or acquire one or more contractual rights whose values are based on intellectual property assets having a common association type. Thus, the criterion or criteria searched upon may include one or more common association types of contractual rights (e.g., a specified range indicating risks of default) or one or more common association types of intellectual property assets (e.g., a particular type of product or service associated with the intellectual property asset(s), a combination of related product(s) and service(s) associated with the intellectual property asset(s), a particular type of product or service associated with the intellectual property asset(s), the particular type of product or service being sold in a particular industry or sold to a particular market segment, or a combination of related product(s) and service(s) associated with the intellectual property asset(s), the combination of related product(s) and services(s) being sold in a particular industry or sold to a particular market segment) associated with one or more contractual rights. The record of FIG. 11 may be modified to include fields corresponding to one or more common association types, such as those identified above.

As noted above, a number of other entities 880, 882 and 884 also interact with the computer system 805 via computers 886, 888 and 890. These entities 880, 882 and 884 may be interested in entering into a transaction to acquire an interest in one of the contractual right(s) identified in the above-mentioned electronic list. If any of the entities 880, 882 and 884 are interested in entering into a transaction involving the contractual rights to receive one or more payments, (including, for example, one or more future payments) in exchange for a transferable interest in one or more intellectual property assets identified in the electronic list, at least a portion of which is made accessible to them, then that entity 880, 882 and 884 may directly contact the entity 825, 830 or 835 that listed the contractual right(s) to negotiate and complete the transaction involving the contractual rights(s).

Preferably, the transaction involving the contractual right(s) is completed using the computer system 805. In particular, the computer system 805 receives over the network 800 from at least one of the entities 880, 882 and 884 an electronic offer (which may be in the form of an e-mail or submitted via a web browser on computers 886, 888 and 890 and processed through an electronic form posted on a web site or at an online facility implemented by a commercial online service) to enter into the transaction.

The computer system 805 would evaluate the information submitted by each of the entities 880, 882 or 884 that would be stored as records in the database system and determine whether the electronic offer is a successful electronic offer based on a particular criterion or combination of criteria, such as the size of the offer amount and/or the creditworthiness of the entity 880, 882 or 884 making the offer. If all of the entities 880, 882 or 884 submit electronic offers to enter into a transaction, then the most favorable offer for the entity 820, 825 and 830 that requested the transaction will be the successful offer.

The entity 880, 882 or 884 submitting the best offer will receive an acceptance notification (such as an electronic acceptance notification which may be in the form of an e-mail or processed through an electronic form posted on a web site) from that entity 820, 825 or 830, or the computer system 805, thereby creating an electronic contract resulting in the transfer (or assignment) of the first contractual right(s) from the entity 820, 825 or 830 to the entity 880, 882 or 884 submitting the best offer.

The acceptance of terms of an electronic contract may be evidenced by a digital signature implemented on the same. A digital signature is an electronic substitute for a manual signature that serves at least the same functions as a manual signature.

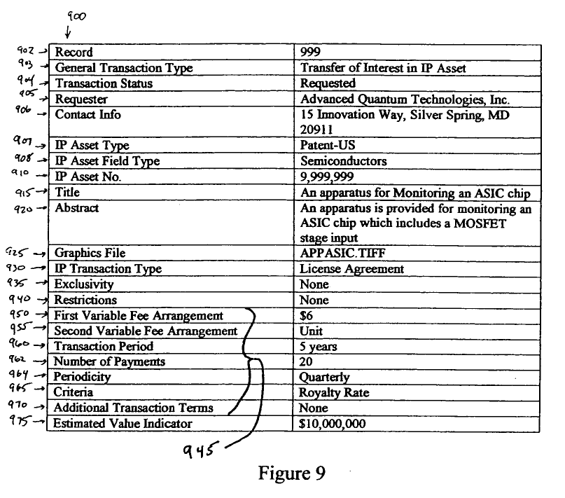

FIG. 9 shows an example of a first record 900 stored in the database system 815, as shown in FIG. 8. The first record 900 comprises a number of fields, and may be stored in, for example, a relational database. However, the information included in the record 900 may be distributed amongst a number of records.

The first record 900 reflects the terms of a requested transaction and comprises information about an intellectual property asset and the nature of the transaction sought by a first entity (such as 820, 825 or 830) in connection with that intellectual property asset. The record 900 may be reviewed, either in whole or in part) by at least a second entity (such as 850, 855 or 860) who may seek to enter into the transaction with the first entity (such as 820, 825 or 830).

By way of example, the first record 900 comprises fields for a unique record identifier 902, a transaction type identifier 903, and a transaction status identifier 904. The transaction type identifier 903 provides an indication of whether the transaction involves a transfer of an interest in one or more intellectual property assets or a transfer of an interest in one or more contractual rights to receive payment(s) (including for example, one or more future payments) in exchange for the transfer of an interest in one or more intellectual property assets. The transaction status identifier 904 provides an indication of the status of the transaction (e.g., whether the record relates to a requested or completed transaction).

The first record 900 may also include fields for the name 905 of the first entity (e.g., Advanced Quantum Technologies, Inc.), who may have a controlling interest in an intellectual property asset, and an address 906 of the first entity. The first record 900 may include a field in which the type of intellectual property asset 907 to which the requested transaction pertains, which in the instant example is a U.S. patent. The first record 900 may also include a field for an intellectual property asset field type identifier 908, which specifies the field, technological or otherwise, to which the intellectual property asset pertains. By way of example, the field may be a technological field relating to semiconductors. The first record 900 may also include a field for a unique identifier 910 associated with the intellectual property asset, which in this case is U.S. Pat. No. 9,999,999. The first record 900 may also include a field for a short descriptive title 915 of the intellectual property asset, which shows that the patent is directed to an apparatus for monitoring an ASIC chip.

The first record 900 may also include a field for an abstract 920 (if necessary), which yields some information about the patented technology. The first record 900 may also include a field for a graphics file 925, which represents a picture of the patented apparatus or some other graphic information concerning the intellectual property asset. The first record 900 may also include a field for the type of intellectual property transaction 930 sought, which in the instant example is a license agreement. Other examples of an intellectual property transaction type 930 include a sales agreement and a lease agreement.

The first record 900 may also include a field for an exclusivity identifier 935 that identifies the exclusivity of the rights conferred by the transaction. In this instance, the license agreement sought would provide an exclusive license to practice the patented apparatus. The first record 900 also comprises a field for restriction identifier(s) 940 which identify restrictions on the scope of the interest being offered in connection with the intellectual property asset (e.g. license), whether territorial or otherwise.

In addition, the first record 900 may also include one or more fields 945 for specifying the fee arrangement (e.g., fields 950, 955, 960, 962, 964 and 970 discussed below). One or more of the fields 945 may be variable fee arrangement indicator(s), and the meaning of each of these variable fee arrangement indicator(s) is determined by the value of the field that specifies the intellectual property transaction type 930. The remaining fields of the fields 945 are not interpreted with reference to the value of the intellectual property transaction type 930.

In the exemplary first record 900 of FIG. 9 there is a field for specifying a first variable fee arrangement indicator 950 and a field for specifying a second variable fee arrangement indicator 955. In the exemplary first record 900 of FIG. 9, the intellectual property transaction type 930 is a license agreement. As such, the first variable fee arrangement indicator 950 may be, for example, a minimum royalty rate sought and the second variable fee arrangement indicator 955 may be, for example, a basis 955 of the royalty rate (e.g., whether the royalty rate will be on a revenue basis or per unit basis). In this instance, the minimum royalty is set at $6 on a per unit basis.

The first record 900 may also include a field specifying the period 960 over which payments would be made for a given fee arrangement. In the instant example, the period is specified as five years. In addition, the first record 900 may also include fields specifying the number of payments 962, as well as the periodicity 964 of those payments (e.g., monthly, quarterly, or yearly). In the instant case, the number of payments is twenty, and those payments will be made on a quarterly basis. The first record 900 may also include a field specifying one or more criteria 965 by which an offer of the second entity (such as 850, 855 or 860) will be evaluated are also specified. In this instance, the royalty rate is specified.

Additional fields may be included in the first record 900, such as a text field 970 specifying additional terms of the transaction. An example of another field that may be included in the first record 900 is an estimated intellectual property value indicator 975, which is an estimate of the value of the intellectual property asset for which a transaction is sought. The estimated value indicator may be provided by the first entity (such as 820, 825 or 830), an assisting entity 807, or another party (not shown) that performs valuation of intellectual properties.

As noted above, the values of the first and second variable fee arrangement indicators 950 and 955 take on different meanings depending on the intellectual property transaction type 930. In the case of an intellectual property transaction type 930 that reflects a sale agreement, which evidences a transaction involving the sale of an intellectual property asset, the value of the first variable fee arrangement indicator 950 may be interpreted, for example, to be the minimum price (e.g. current minimum price in dollars (or other currency) as of the time the transaction is sought) of the intellectual property asset and the value of the second variable fee arrangement indictor 955 may be interpreted, for example, to be the corresponding interest rate if the payments are to be spread out over a particular time period.

As an alternative scheme, the minimum price of the intellectual property asset may be specified (without reference to an interest rate) in terms of a periodic payment amount (which would be reflected by the value of the first variable fee arrangement indicator 950) in conjunction with the specification of (i) the transaction period 960 (over which payments are to be made) and either (1) the number of payments 962 or (2) the periodicity 964, or (ii) the number of payments 962 and the periodicity 964. As such, the value of the second variable fee arrangement indicator 955 would not be used to establish the minimum price of the intellectual property asset.

In the case of an intellectual property transaction type 930 that reflects a lease agreement, which evidences a transaction involving the leasing of an intellectual property asset, the value of the first variable fee arrangement indicator 950 may be interpreted, for example, to be the minimum total payment amount to be made with respect to the intellectual property asset and the value of the second variable fee arrangement indictor 955 may be interpreted, for example, to be the corresponding interest rate if the payments are to be spread out over a particular time period.

As an alternative, the minimum total payment amount that is to be made with respect to the intellectual property asset may be specified (without reference to an interest rate) in terms, for example, of a periodic payment amount (which would be reflected by the value of the first variable fee arrangement indicator 950) in conjunction with the specification of (i) the transaction period 960 (over which payments are to be made) and either (1) the number of payments 962 or (2) the periodicity 964, or (ii) the number of payments 962 and the periodicity 964. As such, the value of the second variable fee arrangement indicator 955 would not be used to establish the minimum total payment amount.

The first record 900 above may be created from e-mails provided by the first entity (such as 820, 825 or 830) or may be entered directly by the first entity (such as 820, 825 or 830) via an electronic form provided through a web site or an online facility maintained by a commercial online service. In addition, the record 900 (either in whole or in part) may be sent to at least a second entity (such as 850, 855 or 860) via an e-mail including information contained in the first record 900 or a hyperlink thereto. Alternatively, the information contained in the first record 900 or a portion thereof, may be made available to the second entity (such as 850, 855 or 860) through a web site or an online facility maintained by a commercial online service. In this way, the second entity (such as 850, 855 or 860) may review the record 900 posted on a web site or an online facility in order to determine whether it is desirable to enter into a transaction with the first entity (such as 820, 825 or 830).

Although the exemplary record 900 is shown with reference to a single intellectual property asset, each such record may contain information relating to one or more intellectual property assets.

FIG. 10 shows an example of a second record 1000 stored in the database system 815, as shown in FIG. 8. The second record 1000 comprises a number of fields, and may be stored in, for example, a relational database. However, the information included in the second record 1000 may be distributed amongst a number of records.

The second record 1000 reflects the terms of a completed transaction and comprises information about an intellectual property asset and the nature of the transaction completed by a first entity (such as 820, 825 or 830) and a second entity (such as 850, 855 or 860) with respect to that intellectual property asset. The second record may be stored in the same database of the database system 815 as the first record 900, or a separate database of the database system 815 reserved for completed transactions (e.g., completed intellectual property transactions).

If the terms of the completed transaction are identical to the terms of the requested transaction, then the first record will differ from the second record 1000 only with respect to the unique record identifier 1002 (shown as field 902 in FIG. 9) and the transaction status identifier 1004 (shown as field 904 in FIG. 9). In some instances, the second record 1000 may include additional details that were not specified by the first entity seeking the transaction involving one or more intellectual property assets. In other instances, differences between the first record 900 and the second record 1000 may reflect the fact that the first entity received a better or worse result than expected from the transaction involving one or more intellectual property assets. The exemplary second record 1000 shown in FIG. 10 reflects the fact that the terms of the transaction, as completed, were identical to the terms sought by the first entity when the request for the transaction was made. As such, only those fields having values that differ from the first record 900 to the second record 1000 are addressed in FIG. 10.

Although the exemplary record 1000 is shown with reference to a single intellectual property asset, each such record may contain information relating to one or more intellectual property assets.

FIG. 11 shows an example of a third record 1100 stored in the database system 815, as shown in FIG. 8. The third record 1100 comprises a number of fields, and may be stored in, for example, a relational database. However, the information included in the third record 1100 may be distributed amongst a number of records.

The third record 1100 reflects the terms of a requested transaction and comprises information about a contractual right to receive one or more future payments (including, for example, future payments) that was received in exchange for the transfer of an interest in one or more intellectual property assets and the nature of the transaction sought by a first entity (such as 820, 825 or 830) with respect to that contractual right. The third record 1100 may be stored in the same database of the database system 815 as the first record 900 and/or second record 1000. Alternatively the third record 1100 may be stored in a separate database of the database system 815 reserved for requested transactions (e.g., requested transactions involving contractual rights to receive payments in exchange for transfer(s) of interest(s) in intellectual property asset(s).

By way of example, the third record 1100 may include fields for a unique record identifier 1102, a transaction type identifier 1103, and a transaction status identifier 1104. The transaction type identifier 1103 provides an indication of whether the transaction involves a transfer of an interest in one or more intellectual property assets or a transfer of an interest in one or more contractual rights to receive payment(s) (including for example, one or more future payments) in exchange for the transfer of an interest in one or more intellectual property assets. The transaction status identifier 1104 provides an indication of the status of the transaction (e.g., whether the record relates to a requested or completed transaction).

The third record 1100 may include a field for an interest identifier 1105, which provides an indication of the type of interest being transferred in connection with the contractual right. By way of example, the interest may be a transfer of the entire ownership interest in the contractual right, or a transfer of a partial ownership interest in the contractual right expressed as a percentage of the total ownership interest being provided for transfer (e.g., 10%, 20% or 50%).

The third record 1100 may also include a field for the unique record identifier 1106 (e.g., the value of the unique record identifier 1002) associated with a record of a completed transaction involving an intellectual property asset that resulted in the receipt of the contractual right to receive one or more royalty payments that, in turn, is the basis for the requested transaction, which is the subject of the third record 1100. Although the unique record identifier 1106 may reflect a transaction involving one or more intellectual property assets that was facilitated by an assisting entity (such as assisting entity 807), it need not always be the case that the transaction was facilitated by an entity assisting with a transaction involving one or more intellectual property assets.

By way of example, an entity (e.g., the first entity 820, 825 or 830) may have independently received one or more contractual rights to receive one or more payments (including, for example, one or more future payments) in exchange for a transfer of an interest in one or more intellectual property assets, without the aid of an assisting entity. In that case, the entity having the contractual right(s) would communicate with an assisting entity (such as assisting entity 807) to request the assisting entity's assistance only with the transaction involving the transfer of an interest in the contractual right(s) and would provide the assisting entity with the information which would form the basis of the third record 1100.

The third record 1100 may also include a field for an estimated contractual right valuation indicator 1107, which provides an indication of a value placed upon the contractual right for which a transaction is sought. The estimated value indicator may be provided by the first entity (such as 820, 825 or 830), an assisting entity 807, or another party (not shown) that performs valuation of contractual rights to receive payments, including future payments, in exchange for a transfer of an interest in one or more intellectual property assets. The third record 1100 may also include at least one field for an estimated value indicator explanation 1108, which is an explanation for the basis of the estimated contractual right valuation indicator 1107 mentioned above. By way of example, the estimated value indicator explanation 1108 may be based on a market, cost or income approach to valuation.

The third record 1100 may also include a field for a security interest indicator 1110, which indicates whether the transferable interest in the contractual right for which a transaction is being sought is being offered with a security interest in at least one or more intellectual property assets, an interest in each of which may have been exchanged for the contractual right. In some instances, a security interest in intellectual property assets may be provided, even when the contractual right to receive one or more payments was not based on a transfer of an interest in those particular intellectual property assets.

The third record 1100 may also include one or more fields identifying the asset type (e.g., intellectual property asset types) in which a security interest is being offered. As an example, the third record 1100 shows a single field identifying such an asset type 1111 (i.e., Patent—U.S.) as being the asset type of the asset in which a security interest is being provided incident to the transaction. Other asset types may include, for example, copyright, trademark, trade secret, other (e.g., a non-intellectual property asset), or a combination of asset types.

The third record 1100 may also include one or more fields identifying the asset(s) (e.g., interests in intellectual property assets) in which a security interest is being offered. As an example, the third record 1100 shows a single field identifying such an asset 1112 (i.e., U.S. Pat. No. 9,999,999) as being the asset in which a security interest is being provided incident to the transaction.

The third record 1100 may also include a field for a security interest file identifier 1113 that provides a name of a file (or a link, such as a hyperlink, thereto) that may be, for example, a PDF, HTML, XML or text-based file including one or more documents that provide legal evidence of the existence of the security interest. This field may be provided by the entity seeking the transaction, the assisting entity, or another entity that provides such documents. The third record 1100 may include multiple fields for multiple security interest file identifiers that provide the name of additional files including documents that provide additional evidence, legal or otherwise, of the existence of the security interest.

Although the third record 1100 has been described in connection with a single contractual right to receive payments in exchange for a transfer of an interest in one or more intellectual property assets, the third record 1100 may be expanded to encompass enough fields for multiple contractual rights to receive payments in exchange for the transfer of interest(s) in one or more intellectual property assets.

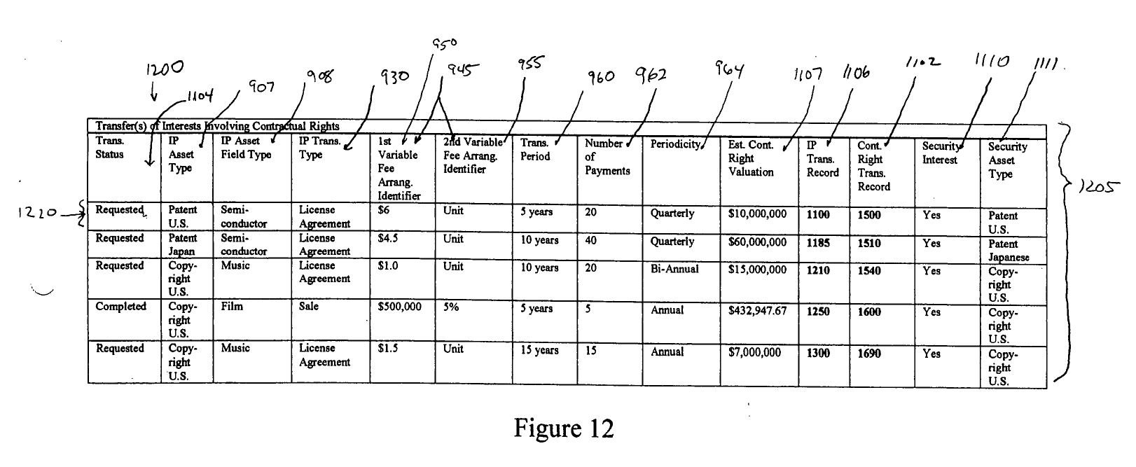

FIG. 12 shows an electronic list that is made accessible to entities for review. The electronic list 1200 identifies requested transactions, each involving the transfer of an interest in one or more contractual rights to receive one or more payments in exchange for the transfer of an interest in one or more intellectual property assets. The list 1200 comprises, by way of example, a table 1205 of contractual rights, an interest in each of which is being made available for transfer to a third party. Each row of the table 1205 relates to one or more of such contractual rights and comprises information concerning the contractual right(s) which is, for example, selected from the type of records described above in connection with the second and third records 1000 and 1100.

By way of example, row 1220 relates to a single contractual right, which is a licensing agreement for which payments, including future payments, are to be received in exchange for the transfer of an interest (i.e., a non-exclusive license) in a U.S. Patent (i.e., U.S. Pat. No. 9,999,999), as reflected in the second and third records 1000 and 1100.

As an example, the table 1205 comprises fields for the transaction status identifier (e.g., 1104), the intellectual property asset type (e.g., 907), the intellectual property asset field type identifier (e.g. 908), and the type of intellectual property transaction (e.g., 930) that the contractual right is based upon (e.g., a license agreement).

In the exemplary table 1205, a field for the interest identifier 1105 is not shown because it is assumed that the interest being transferred in connection with each contractual right is the entire ownership interest, and not a portion thereof. If the transfer of another kind of interest is desired, such as, for example, the transfer of a partial interest, then a field for the interest identifier may be provided in the table.

The table 1205 may also include fields for variable fee arrangement indicators (e.g., the fields 945), such as the first and second variable fee arrangement indicators (e.g., 950 and 955), reflecting for example, a royalty rate and the basis of the royalty rate if the underlying transaction involving intellectual property asset(s) was based on a licensing agreement. The table 1205 may also include fields for the transaction period (e.g., 960) over which payments would be made, the number of payments (e.g., 962), and the periodicity (e.g., 964) of those payments.

The table 1205 may also include fields for the estimated contractual right valuation indicator (e.g., 1107), the unique record identifier (e.g., 1106) of the record embodying the completed transaction involving an intellectual property asset that resulted in the receipt of the contractual right to receive one or more payments, the unique record identifier (e.g. 1102) of the record embodying the requested transaction involving a contractual right to receive payments in exchange for the transfer of interest(s) in one or more intellectual property assets, the security interest indicator (e.g., 1110), and the security interest asset type (e.g., 1111).

The unique record identifiers (e.g., 1102 and 1106) are presented in bold text and represent a link (e.g., hyperlink) to the underlying records (e.g., second and third records 1000 and 1100). In this way, when an entity reviews information in the list as presented, for example, in a web browser, that entity may, if authorized, review the contents of the underlying record by moving the cursor over the unique record identifiers (e.g., 1102 and 1106) in the web browser and “clicking” on the one of those identifiers by pressing a button or key on an input device, such as a mouse. In this manner, each of the underlying records may be provided as part of, for example, a web page in which the selected record is presented as, for example, a table. In this way, the entity may view information not appearing in the list, comprising for example: the unique identifier (e.g., 910) associated with the intellectual property asset, an interest in which was transferred in exchange for a contractual right to receive payments, the exclusivity identifier (e.g., 935), the restriction identifier(s) (e.g., 940), one or more criteria (e.g., 965), a text field (or other type of field) specifying additional terms of the transaction (e.g., 970), the transaction type identifier 1103, the estimated value indicator explanation 1108, and the security interest file identifier 1112.

A link (such as a hyperlink) to the security interest file identifier 1112 may be provided, such that the security interest file may be accessed (e.g., “downloaded”) by moving the cursor over the identifier (e.g., 1112) in a web browser in which the underlying record (e.g., third record 1100) is presented, and “clicking” on the identifier (e.g., 1112) by pressing a button or key on an input device, such as a mouse. The security interest file is provided in response to actuation of the button or key on the input device that initiates a request for the file via, for example, a web browser.

As an alternative, a single unique record identifier can be employed instead of the two unique record identifiers (e.g., 1102 and 1106) to represent a composite record (not shown) that comprises the information presented in two or more records (such as the second ad third records 1000 and 1100). The single unique record identifier may be presented in bold text and represent a link (e.g., hyperlink) to the underlying records (e.g., second and third records 1000 and 1100).

As noted above in connection with FIG. 8(b), the entities 880, 882 and 884 may each make a request via a web browser on the entity's computer 886, 888 and 890 for access to information concerning contractual rights (i.e., contractual rights to receive one or more payments in exchange for transfer(s) of interest(s) in one or more intellectual property assets), an interest, in each of which, is being made available for transfer via, for example, an electronic list. The entities 880, 882 and 884 may each provide as part of the request certain criterion or criteria relating to attributes of the contractual rights that they are interested in acquiring an interest in. Based on the request (comprising, for example, the specified criterion or criteria), the web server invokes an agent 892 residing, for example, on the web server. The agent 892 passes the request (comprising the criteria or criterion) to the database system 815, which may be implemented as, for example, a database server, which executes one or more queries based on the request, using, for example, an SQL procedure. Thereafter, the database system 815 dynamically creates one or more HTML or XML pages, which include the results of the query or queries presented, for example, in the form of the above-mentioned electronic list, and returns the HTML or XML page(s) to the web-browser.

Because the HTML or XML pages are dynamically created, information from records, such as the second and third records may be used to create those pages, which are returned by the web server to the web browser. Also, multiple electronic lists may be provided in response to a request, each featuring, for example, a particular type of contractual right to receive payments in exchange for the transfer of one or more intellectual property rights.

By way of example, each list may be associated with contractual rights based on intellectual properties of a certain type and/or intellectual properties based on a certain type of subject matter. If the intellectual property asset is a patent, then each list may feature a specific kind of technology.

Once the electronic list is dynamically generated, it may be stored in the database system 815 for future retrieval. Static electronic lists may also be created for retrieval

Once the entities 880, 882 and 884 have reviewed the electronic list, they may request contact information (via the computer system 805) for the entity (e.g., the first entity) that made the request for the transaction involving a transfer of an interest in the contractual right. The computer system 805 will query the database system 815 for this information via the agent 892 if the entity 880, 882 or 884 has been qualified (i.e., determined to be authorized to access the information of the database system 815). Although this step may be eliminated by placing a field for the contact information in the above-mentioned row 1220, the first entity may not want divulge itself only to qualified entities.

Alternatively, once the entities 880, 882 and 884 have reviewed the electronic list, they may submit a bid for the contractual right via the computer system 805. The computer system 805 stores each bid in a record in the database system 815 and determines the successful bidder by evaluating the bids in accordance with one or more criteria. Thereafter, the successful bidder is provided with an electronic notification that the bidder is the successful bidder. A record of the completed transaction may be stored in the database system 815.

It will be apparent to those skilled in the art that various modifications and variations can be made to the described and/or claimed methods without departing from the spirit or scope thereof. By way of example, certain exemplary embodiments may also be applied to other intangible assets such as spectrum licenses. Also by way of example, the above-mentioned list of contractual rights may be implemented as a plurality of lists. Thus, it is intended that the present application cover the modifications and variations of the described exemplary embodiments provided they come within the scope of the appended claims and their equivalents.

What is claimed is:

1. A method of facilitating transactions involving one or more contractual rights to receive payments resulting from one or more transfers of rights in one or more intellectual property assets, said method comprising acts comprising at least one computer-implemented act, the acts comprising:
receiving a request to assist with a transaction involving a first intellectual property asset from a first entity, said transaction comprising licensing of said first intellectual property asset;
assisting with the licensing of said first intellectual property asset to a second entity, said licensing resulting in said first entity securing a first contractual right to receive at least a first royalty payment from said second entity; and
providing a third entity with access via a network to a first electronic list identifying a first group of contractual rights to receive royalty payments comprising said first contractual right, wherein a transferable interest in each contractual right of said first group of contractual rights is being made available for transfer to a receiving entity.

2. The method defined in claim 1, wherein said transferable interest in each contractual right of said first group of contractual rights is being made available for transfer along with a security interest in at least one intellectual property asset.

3. The method defined in claim 1, wherein said transferable interest in each contractual right of said first group of contractual rights is being made available for transfer apart from any rights associated with intellectual property assets except a security interest in one or more intellectual property assets.

4. The method defined in claim 1, wherein said receiving entity is said third entity.

5. The method defined in claim 4, wherein said receiving entity is an acquirer from said first entity of a first transferable interest in said first contractual right to receive at least said first royalty payment after accessing said first electronic list.

6. The method defined in claim 5, wherein said first transferable interest is an ownership interest.

7. The method defined in claim 1, wherein said receiving entity is a special purpose vehicle.

8. The method defined in claim 7, wherein said special purpose vehicle is an acquirer from said first entity of a transferable interest in said first contractual right to receive at least said first royalty payment after the third entity accesses said first electronic list.

9. The method defined in claim 8, wherein said special purpose vehicle is established by said third entity.

10. The method defined in claim 1, wherein said first group of contractual rights to receive royalty payments further comprises a second contractual right to receive a t least a second royalty payment.

11. The method defined in claim 10, wherein said second contractual right to receive at least a second royalty payment is based on a transaction involving a second intellectual property asset.

12. The method defined in claim 11, wherein said first group of contractual rights comprises contractual rights to receive payments in exchange for interests in a plurality of intellectual property assets comprising said first intellectual property asset and said second intellectual property asset, said contractual rights of said first group being selected such that said plurality of intellectual property assets have a common association type.

13. The method defined in claim 12, wherein said first list comprises only contractual rights associated with intellectual property assets having a common association type.

14. The method defined in claim 12, wherein a portion of the first electronic list is dedicated to contractual rights associated with intellectual property assets having a common association type.

15. The method defined in claim 10, wherein said first electronic list comprises only contractual rights having a common association type.

16. The method defined in claim 10, wherein a portion of a first electronic list is dedicated to contractual rights having a common association type.

17. The method defined in claim 12, wherein said common association type is based on the plurality of intellectual property assets being associated with a particular type of product.

18. The method defined in claim 12, wherein said common association type is based on the plurality of intellectual property assets being associated with a particular type of service.

19. The method defined in claim 12, wherein said common association type is based on the plurality of intellectual property assets being associated with products sold in particular industry.

20. The method defined in claim 12, wherein said common association type is based on the plurality of intellectual property assets being associated with services sold in a particular industry.

21. The method defined in claim 12, wherein said common association type is based on the plurality of intellectual property assets being associated with products and services sold in a particular industry.

22. The method defined in claim 12, wherein said common association type is based on the plurality of intellectual property assets being associated with products sold to a particular market segment.

23. The method defined in claim 12, wherein said common association type is based on the plurality of intellectual property assets being associated with services sold to a particular market segment.

24. The method defined in claim 12, wherein said common association type is based on the plurality of intellectual property assets being associated with products and services sold to a particular market segment.

25. The method defined in claim 10, wherein said first group of contractual rights are selected such that they have a common association type.

26. The method defined in claim 25, wherein the contractual rights of said first group of contractual rights are associated with corresponding values, which each define a risk of default associated with a contractual right of said first group of contractual rights, wherein said common association type is based on the first group of contractual rights having values that are included within a predetermined range of values.

27. The method defined in claim 1, wherein said request is an electronic request.

28. The method defined in claim 1, wherein said transaction is implemented as an electronic contract.

29. The method defined in claim 1, wherein said first electronic list is a computer-generated electronic list.

30. The method defined in claim 1, wherein said act of assisting with the licensing of said first intellectual property asset to a second entity is accomplished using a vehicle of electronic commerce.

31. The method defined in claim 30, wherein said transaction is implemented as an electronic contract.

32. The method defined in claim 30, wherein said vehicle of electronic commerce is a web site.

33. The method defined in claim 30, wherein said vehicle of electronic commerce is an online facility implemented by a commercial online service.

34. The method defined in claim 30, wherein said request is an electronic request.

35. A method of facilitating transactions involving one or more contractual rights to receive one or more payments resulting from one or more transfers of rights in one or more intellectual property assets, said method comprising acts comprising at least one computer-implemented act, the acts comprising:
receiving a request to assist with a transaction involving a first intellectual property asset from a first entity;
assisting with the transaction, said transaction resulting in said first entity securing a first contractual right to receive at least a first payment from a second entity, said first contractual right being received in exchange for the transfer of a right associated with said first intellectual property asset; and
providing a third entity with access via a network to a first electronic list identifying a first group of contractual rights to receive payments comprising said first contractual right, wherein a transferable interest in each contractual right of said first group of contractual rights is being made available for transfer to a receiving entity.

36. The method defined in claim 35, wherein said transferable interest in each contractual right of said first group of contractual rights is being made available for transfer along with a security interest in at least one intellectual property asset.

37. The method defined in claim 35, wherein said transferable interest in each contractual right of said first group of contractual rights is being made available for transfer apart from any rights associated with intellectual property assets except a security interest in one or more of the intellectual property assets.

38. The method defined in claim 35, wherein said receiving entity is said third entity.

39. The method defined in claim 38, wherein said receiving entity is an acquirer from said first entity of a first transferable interest in said first contractual right to receive at least said first royalty payment after accessing said first electronic list.

40. The method defined in claim 39, wherein said first transferable interest is an ownership interest.

41. The method defined in claim 35, wherein said receiving entity is a special purpose vehicle.

42. The method defined in claim 41, wherein said special purpose vehicle is an acquirer from said first entity of a transferable interest in said first contractual right to receive at least said first royalty payment after the third entity accesses said first electronic list.

43. The method defined in claim 42, wherein said special purpose vehicle is established by said third entity.

44. The method defined in claim 35, wherein said first group of contractual rights to receive royalty payments further comprises a second contractual right to receive at least a second royalty payment.

45. The method defined in claim 44, wherein said second contractual right to receive at least a second royalty payment is based on a transaction involving a second intellectual property asset.

46. The method defined in claim 45, wherein said first group of contractual rights comprises contractual rights to receive payments in exchange for interests in a plurality of intellectual property assets comprising said first intellectual property asset and said second intellectual property asset, said contractual rights of said first group being selected such that said plurality of intellectual property assets have a common association type.

47. The method defined in claim 46, wherein said first electronic list comprises only contractual rights associated with intellectual property assets having a common association type.

48. The method defined in claim 46, wherein a portion of the first electronic list is dedicated to contractual rights associated with intellectual property assets having a common association type.

49. The method defined in claim 44, wherein said first electronic list comprises only contractual rights having a common association type.

50. The method defined in claim 44, wherein a portion of the first electronic list is dedicated to contractual rights having a common association type.

51. The method defined in claim 46, wherein said common association type is based on the plurality of intellectual property assets being associated with a particular type of product.

52. The method defined in claim 46, wherein said common association type is based on the plurality of intellectual property assets being associated with a particular type of service.

53. The method defined in claim 46, wherein said common association type is based on the plurality of intellectual property assets being associated with products sold in a particular industry.

54. The method defined in claim 46, wherein said common association type is based on the plurality of intellectual property assets being associated with services sold in a particular industry.

55. The method defined in claim 46, wherein said common association type is based on the plurality of intellectual property assets being associated with products and services sold in a particular industry.

56. The method defined in claim 46, wherein said common association type is based on the plurality of intellectual property assets being associated with products sold to a particular market segment.

57. The method defined in claim 46, wherein said common association type is based on the plurality of intellectual property assets being associated with services sold to a particular market segment.

58. The method defined in claim 46, wherein said common association type is based on the plurality of intellectual property assets being associated with products and services sold to a particular market segment.

59. The method defined in claim 44, wherein said first group of contractual rights are selected such that they have a common association type.

60. The method defined in claim 59, wherein the contractual rights of said first group of contractual rights are associated with corresponding values, which each define a risk of default associated with a contractual right of said first group of contractual rights, wherein said common association type is based on the first group of contractual rights having values that are included within a predetermined range of values.

61. The method defined in claim 35, wherein said request is an electronic request.

62. The method defined in claim 35, wherein said transaction is implemented as an electronic contract.

63. The method defined in claim 35, wherein said first electronic list is a computer-generated electronic list.

64. The method defined in claim 35, wherein said act of assisting with the licensing of said first intellectual property asset to a second entity is accomplished using a vehicle of electronic commerce.

65. The method defined in claim 64, wherein said transaction is implemented as an electronic contract.

66. The method defined in claim 64, wherein said vehicle of electronic commerce is a web site.

67. The method defined in claim 64, wherein said vehicle of electronic commerce is an online facility implemented by a commercial online service.

68. The method defined in claim 64, wherein said request is an electronic request.

69. A method of facilitating transactions involving contractual rights to receive payments resulting from the transfers of rights in intellectual property assets, said method comprising acts comprising at least one computer-implemented act, the acts comprising:
receiving from a plurality of entities a corresponding plurality of requests to assist with transactions involving intellectual property assets;
assisting with a group of said transactions involving said intellectual property assets, said group of transactions comprising licensing of a group of said intellectual property assets, said licensing resulting in a group of said plurality of entities securing a first group of contractual rights to receive groups of royalty payments from at least one licensee, each of said contractual rights being associated with one of said groups of royalty payments, each of said groups of royalty payments comprising at least one royalty payment; and
providing a reviewing entity with access via a network to a first electronic list identifying a second group of contractual rights to receive royalty payments comprising said first group of contractual rights, wherein a transferable interest in each contractual right of said first group of contractual rights is being made available for transfer to a receiving entity.

70. The method defined in claim 69, wherein said transferable interest in each contractual right of said first group of contractual rights is being made available for transfer along with a security interest in at least one of the group of intellectual property assets.

71. The method defined in claim 69, wherein said transferable interest in each contractual right of said first group of contractual rights is being made available for transfer apart from any rights associated with the group of intellectual property assets except a security interest in at least one of the group of intellectual property assets.

72. The method defined in claim 69, wherein said receiving entity is said reviewing entity.

73. The method defined in claim 72, wherein said receiving entity is an acquirer from a first entity included in said group of said plurality of entities of a first transferable interest in at least a first contractual right included in said first group of contractual rights after accessing said first electronic list.

74. The method defined in claim 73, wherein said first transferable interest is an ownership interest.

75. The method defined in claim 69, wherein said receiving entity is a special purpose vehicle.

76. The method defined in claim 75, wherein said special purpose vehicle is an acquirer from a first entity included in said group of said plurality of entities of a transferable interest in a first contractual right included in said second group of contractual rights after the reviewing entity accesses said first electronic list.

77. The method defined in claim 76, wherein said special purpose vehicle is established by said reviewing entity.

78. The method defined in claim 69, wherein at least one of said plurality of entities is in bankruptcy.

79. The method defined in claim 69, wherein said contractual rights of said first group of contractual rights are selected such that said group of said intellectual property assets have a common association type.

80. The method defined in claim 69, wherein said first electronic list comprises only contractual rights associated with intellectual property assets having a common association type.

81. The method defined in claim 69, wherein a portion of the first electronic list is dedicated to contractual rights associated with intellectual property assets having a common association type.

82. The method defined in claim 69, wherein said first electronic list comprises only contractual rights having a common association type.

83. The method defined in claim 69, wherein a portion of the first electronic list is dedicated to contractual rights having a common association type.

84. The method defined in claim 79, wherein said common association type is based on said group of said intellectual property assets being associated with a particular type of product.

85. The method defined in claim 79, wherein said common association type is based on said group of said intellectual property assets being associated with a particular type of service.

86. The method defined in claim 79, wherein said common association type is based on said group of said intellectual property assets being associated with products sold in a particular industry.

87. The method defined in claim 79, wherein said common association type is based on said group of said intellectual property assets being associated with services sold in a particular industry.

88. The method defined in claim 79, wherein said common association type is based on said group of said intellectual property assets being associated with products and services sold in a particular industry.

89. The method defined in claim 79, wherein said common association type is based on said group of said intellectual property assets being associated with products sold to a particular market segment.

90. The method defined in claim 79, wherein said common association type is based on said group of said intellectual property assets being associated with services sold to a particular market segment.

91. The method defined in claim 79, wherein said common association type is based on said group of said intellectual property assets being associated with products and services sold to a particular market segment.

92. The method defined in claim 69, wherein said first group of contractual rights are selected such that they have a common association type.

93. The method defined in claim 92, wherein the contractual rights of said first group of contractual rights are associated with corresponding values, which each define a risk of default associated with a contractual right of said first group of contractual rights, wherein said common association type is based on the first group of contractual rights having values that are included within a predetermined range of values.

94. The method defined in claim 69, wherein said plurality of requests is a plurality of electronic requests.

95. The method defined in claim 69, wherein said group of said transactions is implemented as a group of electronic contracts.

96. The method defined in claim 69, wherein said first electronic list is a computer-generated electronic list.

97. The method defined in claim 69, wherein said act of assisting with a group of said transactions is accomplished using a vehicle of electronic commerce.

98. The method defined in claim 97, wherein said group of transactions is implemented as a group of electronic contracts.

99. The method defined in claim 97, wherein said vehicle of electronic commerce is a web site.

100. The method defined in claim 97, wherein said vehicle of electronic commerce is an online facility implemented by a commercial online service.

101. The method defined in claim 97, wherein said plurality of requests is a plurality of electronic requests.

102. A method of facilitating transactions involving contractual rights to receive payments resulting from transactions involving intellectual property assets, said method comprising:
providing a first electronic list that is accessible by a plurality of entities via a network, said first electronic list identifying a plurality of contractual rights to receive payments resulting from transactions involving at least a first intellectual property asset, said first electronic list further identifying a transferable interest in each contractual right of said plurality of contractual rights that is being made available for transfer to a receiving entity.

103. The method defined in claim 102, wherein said transferable interest in at least one contractual right of said plurality of contractual rights is being made available for transfer along with a security interest in at least one intellectual property asset.

104. The method defined in claim 102, wherein said transferable interest in at least one contractual right of said plurality of contractual rights is being made available for transfer apart from any rights associated with intellectual property assets except a security interest in at least one of the intellectual property assets.

105. The method defined in claim 102, wherein at least one of said transactions is implemented as an electronic contract.

106. The method defined in claim 102, wherein the step of providing comprises the step of providing said first electronic list via said network using a vehicle of electric commerce.

107. The method defined in claim 102, wherein said vehicle of electronic commerce is a web site.

108. The method defined in claim 102, wherein the act of providing a first electronic list accessible by an entity via said network comprises providing a first electronic list to the entity via an e-mail sent via said network.

109. The method defined in claim 102, wherein said vehicle of electronic commerce is an online facility implemented by a commercial online service.

110. The method defined in claim 102, wherein said transactions include a licensing of the first intellectual property asset.

111. The method defined in claim 102, wherein said transactions include a leasing of the first intellectual property asset.

112. The method defined in claim 102, wherein said transactions include a sale of the first intellectual property asset.

113. The method defined in claim 102, wherein said plurality of contractual rights to receive payments further comprises a second contractual right to receive at least a second payment.

114. The method defined in claim 113, wherein said second contractual right to receive at least a second payment is based on a transaction involving a second intellectual property asset.

115. The method defined in claim 114, wherein said plurality of contractual rights comprises contractual rights to receive payments in exchange for interests in a plurality of intellectual property assets comprising said first intellectual property asset and said second intellectual property asset, said contractual rights of said plurality of contractual rights being selected such that said plurality of intellectual property assets have a common association type.

116. The method defined in claim 115, wherein said first electronic list comprises only contractual rights associated with intellectual property assets having a common association type.

117. The method defined in claim 115, wherein a portion of the first electronic list is dedicated to contractual rights associated with intellectual property assets having a common association type.

118. The method defined in claim 113, wherein said first electronic list comprises only contractual rights having a common association type.

119. The method defined in claim 113, wherein a portion of the first electronic list is dedicated to contractual rights having a common association type.

120. The method defined in claim 115, wherein said common association type is based on the plurality of intellectual property assets being associated with a particular type of product.

121. The method defined in claim 115, wherein said common association type is based on the plurality of intellectual property assets being associated with a particular type of service.

122. The method defined in claim 115, wherein said common association type is based on the plurality of intellectual property assets being associated with products sold in a particular industry.

123. The method defined in claim 115, wherein said common association type is based on the plurality of intellectual property assets being associated with services sold in a particular industry.

124. The method defined in claim 115, wherein said common association type is based on the plurality of intellectual property assets being associated with products and services sold in a particular industry.

125. The method defined in claim 115, wherein said common association type is based on the plurality of intellectual property assets being associated with products sold to a particular market segment.

126. The method defined in claim 115, wherein said common association type is based on the plurality of intellectual property assets being associated with services sold to a particular market segment.

127. The method defined in claim 115, wherein said common association type is based on the plurality of intellectual property assets being associated with products and services sold to a particular market segment.

128. The method defined in claim 113, wherein said first group of contractual rights are selected such that they have a common association type.

129. The method defined in claim 128, wherein the contractual rights of said first group of contractual rights are associated with corresponding values, which each define a risk of default associated with a contractual right of said first group of contractual rights, wherein said common association type is based on the first group of contractual rights having values that are included within a predetermined range of values.

130. An apparatus implemented in a network, said apparatus comprising:
one or more processors coupled to a memory storing a first electronic list accessible by a plurality of entities via said network, said first electronic list identifying a plurality of contractual rights to receive payments resulting from transactions involving at least a first intellectual property asset, said first electronic list further identifying a transferable interest in each contractual right of the plurality of contractual rights that is being made available for transfer.

131. The apparatus defined in claim 130, wherein said transferable interest in each contractual right of said plurality of contractual rights is being made available for transfer along with a security interest in at least one intellectual property asset.

132. The apparatus defined in claim 131, wherein the availability of said security interest is identified in said first electronic list along with a corresponding one of the plurality of contractual rights.

133. The apparatus defined in claim 130, wherein said transferable interest in each contractual right of the plurality of contractual rights is being made available for transfer apart from any rights associated with intellectual property assets except a security interest in at least one of the intellectual property assets.

134. The apparatus defined in claim 133, wherein the availability of said security interest is identified in said first electronic list along with a corresponding contractual right of the plurality of contractual rights.

135. The apparatus defined in claim 131, further comprising at least one database having data comprising said first electronic list, and database management software for managing said data.

136. The apparatus defined in claim 131, wherein said network comprises a local area network.

137. The apparatus defined in claim 131, wherein said network comprises a local area network.

138. The apparatus defined in claim 131, wherein said network comprises a wide area network.

139. The apparatus defined in claim 131, wherein said network comprises a wireless network.

140. The apparatus defined in claim 130, wherein the plurality of contractual rights to receive royalty payments further comprises a second contractual right to receive at least a second royalty payment.

141. The apparatus defined in claim 140, wherein the second contractual right to receive at least a second royalty payment is based on a transaction involving a second intellectual property asset.

142. The apparatus defined in claim 141, wherein the plurality of contractual rights comprises contractual rights to receive payments in exchange for interests in a plurality of intellectual property assets comprising said first intellectual property asset and said second intellectual property asset, said contractual rights of the plurality of contractual rights being selected such that the plurality of intellectual property assets have a common association type.

143. The apparatus defined in claim 142, wherein said first electronic list comprises only contractual rights associated with intellectual property assets having a common association type.

144. The apparatus defined in claim 142, wherein a portion of the first electronic list is dedicated to contractual rights associated with intellectual property assets having a common association type.

145. The apparatus defined in claim 140, wherein the first electronic list comprises only contractual rights having a common association type.

146. The apparatus defined in claim 140, wherein a portion of the first electronic list is dedicated to contractual rights having a common association type.

147. The apparatus defined in claim 142, wherein said common association type is based on the plurality of intellectual property assets being associated with a particular type of product.

148. The apparatus defined in claim 142, wherein said common association type is based on the plurality of intellectual property assets being associated with a particular type of service.

149. The apparatus defined in claim 142, wherein said common association type is based on the plurality of intellectual property assets being associated with products sold in a particular industry.

150. The apparatus defined in claim 142, wherein said common association type is based on the plurality of intellectual property assets being associated with services sold in a particular industry.

151. The apparatus defined in claim 142, wherein said common association type is based on the plurality of intellectual property assets being associated with products and services sold in a particular industry.

152. The apparatus defined in claim 142, wherein said common association type is based on the plurality of intellectual property assets being associated with products sold to a particular market segment.

153. The apparatus defined in claim 142, wherein said common association type is based on the plurality of intellectual property assets being associated with services sold to a particular market segment.

154. The apparatus defined in claim 142, wherein said common association type is based on the plurality of intellectual property assets being associated with products and services sold to a particular market segment.

155. The apparatus defined in claim 140, wherein the plurality of contractual rights is selected such that they have a common association type.

156. The apparatus defined in claim 155, wherein the contractual rights of the plurality of contractual rights are associated with corresponding values, which each define a risk of default associated with a contractual right of the plurality of contractual rights, wherein said common association type is based on the plurality of contractual rights having values that are included within a predetermined range of values.

157. The apparatus defined in claim 130, wherein said transactions include a licensing of the intellectual property asset.

158. The apparatus defined in claim 130, wherein said transactions include a leasing of the intellectual property asset.

159. The apparatus defined in claim 130, wherein said transactions include a sale of the intellectual property asset.

160. A computer readable medium carrying one or more instructions which, when executed by one or more processors coupled to a memory, cause the one or more processors to store in the memory information that is used to generate an electronic list that is made accessible to a plurality of entities via a network, said electronic list identifying a plurality of contractual rights to receive payments resulting from transactions involving at least a first intellectual property asset, said electronic list further identifying a transferable interest in each contractual right of said plurality of contractual rights that is being made available for transfer to another entity.

161. The computer readable medium defined in claim 160, wherein said transferable interest in at least one contractual right of said plurality of contractual rights is being made available for transfer along with a security interest in at least one intellectual property asset.

162. The computer readable medium defined in claim 161, wherein the availability of said security interest is identified in said electronic list along with a corresponding contractual right of said plurality of contractual rights.

163. The computer readable medium defined in claim 160, wherein said transferable interest in each contractual right of said plurality of contractual rights is being made available for transfer apart from any rights associated with intellectual property assets except a security interest in one or more intellectual property assets.

164. The computer readable medium defined in claim 163, wherein the availability of said security interest is identified in said electronic list along with a corresponding contractual right of said plurality of contractual rights.

165. The computer readable medium defined in claim 160, wherein the plurality of contractual rights to receive payments further comprises a second contractual right to receive at least a second payment.

166. The computer readable medium defined in claim 165, wherein said second contractual right to receive at least a second payment is based on a transaction involving a second intellectual property asset.

167. The computer readable medium defined in claim 166, wherein the plurality of contractual rights comprises contractual rights to receive payments in exchange for interests in a plurality of intellectual property assets comprising said first intellectual property asset and said second intellectual property asset, said contractual rights of said first group being selected such that said plurality of intellectual property assets have a common association type.

168. The computer readable medium defined in claim 167, wherein said electronic list comprises only contractual rights associated with intellectual property assets having a common association type.

169. The computer readable medium defined in claim 167, wherein a portion of the electronic list is dedicated to contractual rights associated with intellectual property assets having a common association type.

170. The computer readable medium defined in claim 167, wherein said electronic list comprises only contractual rights having a common association type.

171. The computer readable medium defined in claim 167, wherein a portion of the electronic list is dedicated to contractual rights having a common association type.

172. The computer readable medium defined in claim 167, wherein said common association type is based on the plurality of intellectual property assets being associated with a particular type of product.

173. The computer readable medium defined in claim 167, wherein said common association type is based on the plurality of intellectual property assets being associated with a particular type of service.

174. The computer readable medium defined in claim 167, wherein said common association type is based on the plurality of intellectual property assets being associated with products sold in a particular industry.

175. The computer readable medium defined in claim 167, wherein said common association type is based on the plurality of intellectual property assets being associated with services sold in a particular industry.

176. The computer readable medium defined in claim 167, wherein said common association type is based on the plurality of intellectual property assets being associated with products and services sold in a particular industry.

177. The computer readable medium defined in claim 167, wherein said common association type is based on the plurality of intellectual property assets being associated with products sold to a particular market segment.

178. The computer readable medium defined in claim 167, wherein said common association type is based on the plurality of intellectual property assets being associated with services sold to a particular market segment.

179. The computer readable medium defined in claim 167, wherein said common association type is based on the plurality of intellectual property assets being associated with products and services sold to a particular market segment.

180. The computer readable medium defined in claim 165, wherein the plurality of contractual rights is selected such that they have a common association type.

181. The computer readable medium defined in claim 180, wherein the contractual rights of the plurality of contractual rights are associated with corresponding values, which each define a risk of default associated with a contractual right of said first group of contractual rights, wherein said common association type is based on the first group of contractual rights having values that are included within a predetermined range of values.

182. The computer readable medium defined in claim 160, wherein the transactions include a licensing of the first intellectual property asset.

183. The computer readable medium defined in claim 160, wherein the transactions include a leasing of the first intellectual property asset.

184. The computer readable medium defined in claim 160, wherein the transactions include a sale of the first intellectual property asset.

185. A method of acquiring at least a first contractual right to receive at least one payment from a first entity, said first contractual right having been received by said first entity from a second entity in exchange for the transfer to said second entity of a right associated with at least a first intellectual property asset, the method comprising the acts of:
via a network, accessing an electronic list identifying a first group of contractual rights to receive payments in exchange for the transfer of rights associated with intellectual property assets, said first group of contractual rights comprising said first contractual right, wherein a transferable interest in each contractual right of said first group of contractual rights is being made available for transfer to a receiving entity;
acquiring a second group of contractual rights to receive payments selected from said first group of contractual rights after having accessed said electronic list, said second group comprising said first contractual right.

186. The method defined in claim 185, wherein said transferable interest in each contractual right of said first group of contractual rights is being made available for transfer along with a security interest in at least one intellectual property asset.

187. The method defined in claim 185, wherein said transferable interest in each contractual right of said first group of contractual rights is being made available for transfer apart from any rights associated with intellectual property assets except a security interest in one or more intellectual property assets.

188. The method defined in claim 185, wherein said second group further comprises a second contractual right received in exchange for the transfer to said second entity of a right associated with said first intellectual property asset.

189. The method defined in claim 185, wherein said second group further comprises a second contractual right received in exchange for the transfer to another entity of a right associated with a second intellectual property asset.

190. The method defined in claim 185, wherein the method further comprises the act of transferring said first contractual right to a special purpose vehicle to facilitate an issuance of securities backed by at least said first contractual right.

191. The method defined in claim 185, wherein the method further comprises the act of transferring said second group of contractual rights to a special purpose vehicle to facilitate an issuance of securities backed by said second group of contractual rights.

192. The method defined in claim 185, wherein said act of accessing comprises accessing said electronic list via a network.

193. The method defined in claim 192, wherein said act of accessing comprises accessing said electronic list via a vehicle of electronic commerce.

194. The method defined in claim 193, wherein said vehicle of electronic commerce is a web site.
